(19) United States
(12) Patent Application Publication
(10) Pub. No.: US 2010/0005306 A1
(43) Pub. Date: Jan. 7, 2010

(54) STORAGE MEDIA STORING ELECTRONIC DOCUMENT MANAGEMENT PROGRAM, ELECTRONIC DOCUMENT MANAGEMENT APPARATUS, AND METHOD TO MANAGE ELECTRONIC DOCUMENT

(75) Inventors: Tetsuya Izu, Kawasaki (JP); Masahiko Takenaka, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/170,231

(22) Filed: Jul. 9, 2008

(30) Foreign Application Priority Data
Jul. 11, 2007 (JP) 2007-182517

(51) Int. Cl. H04L 9/32

(52) U.S. Cl. 713/176

(57) ABSTRACT

An electronic document management apparatus acquires an electronic document comprised of a plurality of components for each of which a first digital signature and a second digital signature are uniquely specified. The electronic document is linked to an aggregate digital signature which aggregates the first digital signatures. After that the apparatus accepts designation of a component to be “hiding prohibited” within the electronic document. Whether or not the component designated to be “hiding prohibited” is at that time in a state of “hiding allowed and deletion allowed” is judged. When the judgment reveals that the state is “hiding allowed and deletion allowed”, the second digital signature specified for the component designated to be “hiding prohibited” is deleted. Then the state of the component subject to be “hiding prohibited” is changed from “hiding allowed and deletion allowed” to “hiding prohibited and deletion allowed”.

### TECHNICAL FIELD

The present disclosure relates to an electronic document management program to manage an electronic document the authenticity of which can be verified, storage media storing the program, an electronic document management apparatus, and a method to manage such electronic documents.

### BACKGROUND OF THE INVENTION

Technology using a digital signature has been developed to verify authenticity of an electronic document. The digital signature technology guarantees authenticity of the document by applying a digital signature to each document, thereby enabling authentication of an author of an electronic document to determine validity of the document.

Therefore using the digital signature technology is advantageous for preventing a falsification by an unauthorized user. On the other hand, the technology has drawbacks in terms of effective use of electronic documents since validity of an electronic document is not guaranteed after any redaction is applied to the document.

Consequently, various redactions cannot be applied such as deleting information which cannot be disclosed or unnecessary information from an electronic document. This leads to substantial deterioration of usability. Under these circumstances, technology that allows both a redaction and a verification of authenticity of an electronic document has been sought.

For example, technology has been developed that applies sanitization to a partially undisclosed document. This is achieved by separating an electronic document into partial documents and then designating each partial document as disclosed or undisclosed. This sanitizable digital signature scheme can guarantee integrity of disclosed parts and confidentiality of undisclosed parts, i.e. the sanitized part of an electronic document.

Other technology can delete the undisclosed partial document and guarantee integrity of the electronic document. This is achieved by separating an electronic document into partial documents, applying a digital signature for each partial document and designating disclosed and undisclosed for each partial document (e.g., Japanese Laid-open Patent Publication No. 2006-60722). This deletable digital signature scheme can guarantee integrity of the disclosed part and confidentiality of the undisclosed part (i.e. deleted part) of an electronic document.

Technology that applies sanitization and deletion of an undisclosed partial document is known as well. This is achieved by separating an electronic document into partial documents and designating disclosed and undisclosed for each partial document. This sanitizable and deletable digital signature scheme allows both sanitization and deletion of the same document. Thus, integrity of the disclosed part and confidentiality of the undisclosed part (i.e. sanitized and deleted parts) of an electronic document are guaranteed.

Above sanitizable and deletable digital signature scheme allows settings of various states regarding sanitization and deletion for each partial document. Now various states that are set for each partial document will be explained by referring to conventional sanitizable and deletable signature schemes.

FIG. 34 is a diagram illustrating states of a partial document and the transitions in conventional technology. In FIG. 34, a diagram 3400 illustrates various states that can be set for each partial document. More specifically, six states are represented by a combination of the following attributes: Sanitization and Deletion related, and Prohibited, Allowed, and Sanitized or Deleted.

These six states are represented as follows: Sanitization Allowed and Deletion Allowed (SADA), Sanitization Prohibited and Deletion Prohibited (SPDP), Sanitization Allowed and Deletion Prohibited (SADP), Sanitized and Deletion Allowed (SDA), Sanitized and Deletion Prohibited (SDP), and Deleted (D).

For state transitions indicating the transitions between these states, nine states of transitions from Ta to Ti are shown. For example, a state transition Ta indicates transition from Sanitization Allowed and Deletion Allowed (SADA) to Sanitization Prohibited and Deletion Prohibited (SPDP).

These six states and nine state transitions are not simply set as a property for a partial document but are physically set by a data retention method. This allows various settings for a partial document depending on whether it is to be disclosed or undisclosed, or whether redaction is allowed or not. Thus, information leakage of an electronic document due to, for example, by incorrect settings of a property can be prevented.

The above technology, however, does not allow settings of a partial document to be changed to or from Sanitization Prohibited and Deletion Allowed (SPDA). This results in deterioration of usability since the technology does not allow settings that sanitization is prohibited and deletion allowed where a partial document exists, and for some reason allows deletion but prohibits sanitization.

Now, drawbacks of above technology will be explained more specifically. FIG. 35 is an explanatory diagram illustrating an example of drawbacks of conventional technology. In FIG. 35, an original document 3510 is an electronic document indicating results of a public works tender conducted by a certain city (XXX city). More specifically, the first page shows information including a name of a successful tender (AAA construction company), and an amount (JPY 500,000).

The second page shows information including another tender's name (BBB construction company) and the amount (JPY 400,000). The third page shows information including yet another tender's name (CCC construction company) and the amount (JPY 300,000). A digital signature X indicating an official seal of the XXX city is applied to this original document 3510. Here, pages from 1 to 3 are assumed to be from P1 to P3.

When a disclosure of the tender results is requested, and the original document 3510 is disclosed as it is, the names and amounts shown in the partial documents P2 and P3 are disclosed. In this case, partial concealment of the original document 3510 is required to protect personal information.

The concealment of partial information can be realized by redacting the original document 3510 using the sanitizable and deletable signature scheme. A redacted document 3520 is a document from which confidential personal information is deleted. At the disclosure of the document 3520, the confidential personal information is deleted. Therefore a reader cannot identify specific contents of partial documents P2 and P3. That means the personal information is appropriately protected and the redacted document 3520 is a desirable document.

A redacted document 3530 is an electronic document to which sanitization is applied to the confidential personal information of the original document 3510. At the disclosure of the document 3530, the confidential personal information is sanitized. Therefore a reader cannot identify specific contents of partial documents P2 and P3. However, confidentiality cannot necessarily be guaranteed. For example, the number of tenders can be estimated based on the sanitized partial documents P2 and P3. Thus the redacted the document 3530 is not a desirable document.

In order to avoid these circumstances, a scheme has been sought that allows setting the P2 and P3 to “Sanitization Prohibited and Deletion Allowed” (SPDA) at the time of creating the original document 3510, thereby preventing selection of sanitization for the purpose of hiding the partial documents P2 and P3.

### SUMMARY

An electronic document management apparatus acquires an electronic document having a plurality of components for each of which a first digital signature and a second digital signature are uniquely specified. The document is linked to an aggregate digital signature of the first digital signatures of the components.

After that the apparatus accepts designation of a component to be “hiding prohibited”. Then, whether or not the component designated to be hiding prohibited is in a state of hiding allowed and deletion allowed is judged. When the judgment reveals that the state is “hiding allowed” and “deletion allowed”, the second digital signature specified for the component designated to be “hiding prohibited” is deleted.

Then the state of the component subject to be “hiding prohibited” is changed from “hiding allowed and deletion allowed” to “hiding prohibited and deletion allowed”.

### BRIEF DESCRIPTION OF THE DRAWINGS

FIG. 1 illustrates a system configuration of an electronic document management system according to the embodiment;

FIG. 2 illustrates a hardware configuration of an electronic document management apparatus according to the first embodiment;

FIG. 3 is a block diagram illustrating a functional configuration of an electronic document management apparatus according to the first embodiment;

FIGS. 4A and 4B is a flow chart illustrating processing procedures for redaction by the electronic document management apparatus according to the first embodiment;

FIG. 5 is a flow chart illustrating processing procedures of verification by the electronic document management apparatus according to the first embodiment;

FIG. 6 is a diagram illustrating states of a partial document and the state transition;

FIG. 7 is an explanatory diagram illustrating a summary of generating digital signatures;

FIG. 8 is an explanatory diagram illustrating an example of initial state of an electronic document M according to the first embodiment;

FIG. 9 is an explanatory diagram illustrating a method for representing states of partial documents according to the first embodiment;

FIGS. 10A and 10B is a flow chart illustrating processing procedures for redaction according to the first embodiment;

FIG. 11 is a flow chart illustrating processing procedures for redaction according to the first embodiment;

FIG. 12 is a flow chart illustrating processing procedures for redaction according to the first embodiment;

FIG. 13 is a flow chart illustrating processing procedures for redaction according to the first embodiment;

FIG. 14 is a flow chart illustrating processing procedures for redaction according to the first embodiment;

FIG. 15 is a flow chart illustrating processing procedures for a redaction according to the first embodiment;

FIG. 16 is a flow chart illustrating processing procedures for a redaction according to the first embodiment;

FIG. 17 is a flow chart illustrating processing procedures for verification by the electronic document management apparatus according to the first embodiment;

FIG. 18 is an explanatory diagram illustrating an example of an initial state of an electronic document M according to a second embodiment;

FIG. 19 is an explanatory diagram illustrating a method for representing states of partial documents according to the second embodiment;

FIG. 20 is a flow chart illustrating processing procedures for redaction according to the second embodiment;

FIG. 21 is a flow chart illustrating processing procedures for redaction according to the second embodiment

FIG. 22 is a flow chart illustrating processing procedures for redaction according to the second embodiment;

FIG. 23 is an explanatory diagram illustrating a method for representing states of partial documents according to a third embodiment;

FIG. 24 is a flow chart illustrating processing procedures for redaction according to the third embodiment;

FIG. 25 is a flow chart illustrating processing procedures for a redaction according to the third embodiment;

FIG. 26 is a flow chart illustrating processing procedures for a redaction according to the third embodiment;

FIG. 27 is an explanatory diagram illustrating an example of drawbacks when a state of sanitization prohibited is not used;

FIG. 28 is a diagram illustrating states of a partial document and related state transitions;

FIG. 29 is an explanatory diagram illustrating an example of an initial state of an electronic document M according to a fourth embodiment;

FIG. 30 is an explanatory diagram illustrating a method for representing states of partial documents according to the fourth embodiment;

FIG. 31 is a flow chart illustrating processing procedures for redaction according to the fourth embodiment;

FIG. 32 is a flow chart illustrating processing procedures for redaction according to the fourth embodiment;

FIG. 33 is a flow chart illustrating processing procedures for redaction according to the fourth embodiment;

FIG. 34 is a diagram illustrating states of a partial document and related state transitions of conventional technologies;

FIG. 35 is an explanatory diagram illustrating an example of drawbacks of conventional technology.

### DETAILED DESCRIPTION OF THE EMBODIMENTS

Referring to the drawings, detailed embodiments are explained.

### [System Configuration of Electronic Document Management System 100]

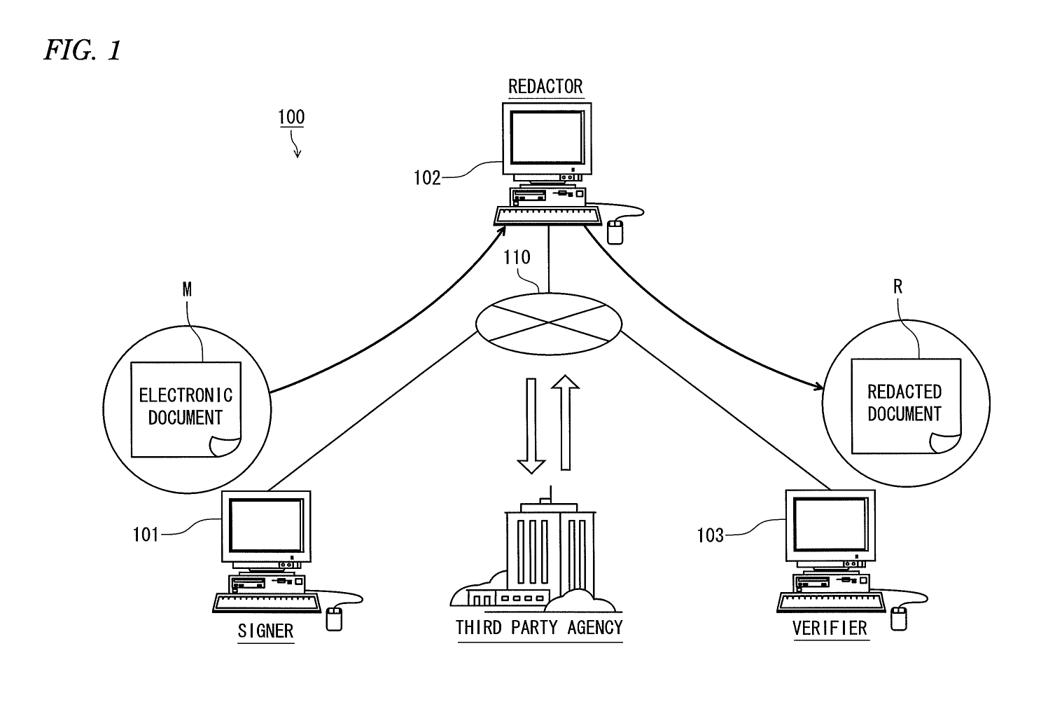

FIG. 1 is a diagram illustrating a system configuration of an electronic document management system according to a first embodiment.

In FIG. 1, an electronic document management system 100 includes a plurality of electronic document management systems 101, 102, and 103 (i.e. three systems in FIG. 1) connected to each other via a network 110 such as Internet, LAN, and WAN to enable communication among them.

The electronic document management system 101 is a computer apparatus used by a signer who applies a digital signature to an electronic document M. The signer can apply a digital signature to guarantee authenticity of the electronic document M by using the system 101. More specifically, the signer applies a digital signature generated using a secret key of the signer to the electronic document M.

The electronic document M is a document having confidential information such as electronic family registrations issued by administrative agencies, electronic medical charts issued by medical institutions, and electronic report cards issued by educational institutions. Such electronic documents may include official documents obtainable by requesting their disclosure to municipal administrative agencies.

An electronic document management apparatus 102 is a computer apparatus used by a redactor of the electronic document M to which the digital signature has been applied. The redactor can create a redacted document R by changing (or setting) the state of partial documents comprising the electronic document M.

The electronic document management apparatus 103 is a computer apparatus used by a verifier who verifies authenticity of the redacted document R. The verifier can verify an authenticity of the redacted document R using the apparatus 103. At this time, the authenticity of the redacted document R is verified using a secret key issued by a third party agency.

Computer apparatuses used by the signer, the redactor, and the verifier are assumed to be electronic document management apparatus 101, 102, and 103 respectively, but are not limited to these. For example, applying a signature, and redacting and verifying a document can be performed with one computer apparatus (e.g., the electronic document management system 101). Redactions to the electronic document M can be additionally applied by a plurality of redactors.

A flow of application of a signature to the electronic document M, and redaction and verification of the electronic document M will now be explained. First, at the electronic document management system 101, a signer applies a digital signature to the electronic document M. Then at the electronic document management system 102, a redactor redacts the electronic document M to which a digital signature has been applied. The redacted document R is transmitted from the electronic document management apparatus 102 to the electronic document management apparatus 103 in response to, for example, a disclosure request by a verifier. Then the apparatus 103 verifies authenticity of the redacted document R.

### [Hardware Configuration of Electronic Document Management Apparatus]

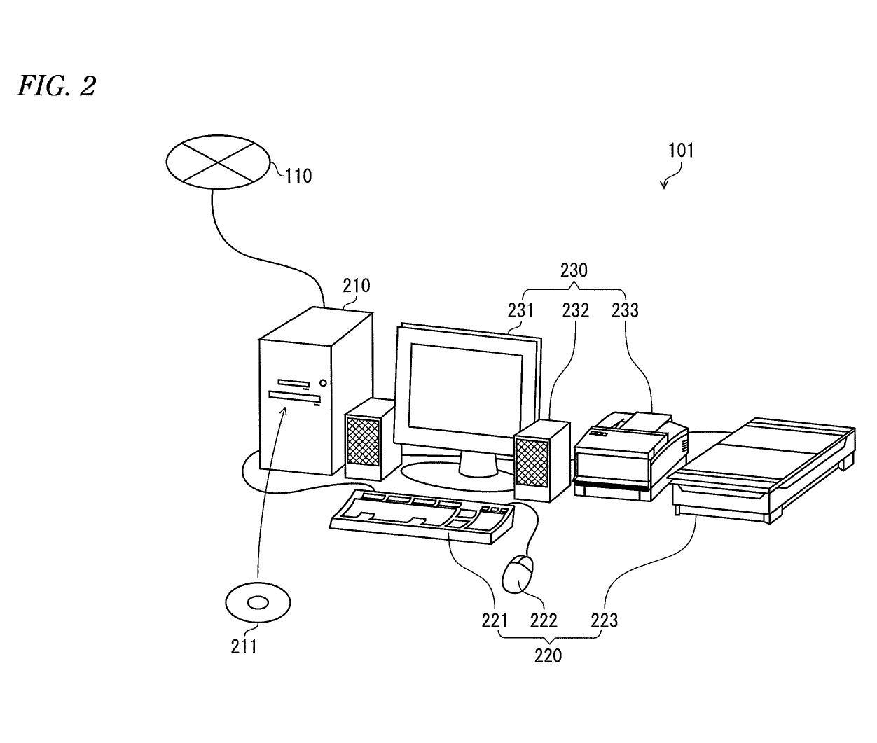

First, a hardware configuration of the electronic document management apparatuses 101, 102, and 103 of an embodiment of the present disclosure is explained (hereunder, simply referred to as “electronic document management apparatus 101”). FIG. 2 is an explanatory diagram illustrating a hardware configuration of an embodiment of the present disclosure.

In FIG. 2, the electronic document management apparatus 101 is comprised of a computer main body 210, an input apparatus 220, and an output apparatus 230. These are connectable to the network 110 such as a local area network (LAN), a wide area network (WAN), and the Internet via a router or a modem (not shown in FIG. 2).

The computer main body 210 provides a CPU, memories, and an interface. The CPU controls the electronic document management apparatus 101. The memories include a read only memory (ROM), a random access memory (RAM), a hard disk (HD), an optical disk and a flash memory. Memories are used as a work area of the CPU.

Various programs are stored in the memory and are loaded by an instruction of the CPU. A disk drive controls read and write of the HD and the optical disk 211. The optical disk 211 and the flash memory are attachable to and detachable from the computer main body 210. The interface controls input from the input device 220, output to an output device 230, and send and receive to and from the network 110.

The input device 220 includes a keyboard 221, a mouse 222, and a scanner 223. The keyboard 221 provides keys for inputting characters, numbers, and various instructions and performs data input. A touch-panel keyboard may be used. The mouse 222 moves a cursor, selects area, moves a window, and changes the size, etc. The scanner 223 optically reads an image. The optically read image is taken as image data and stored in the memory of the computer main body 210. The scanner 223 can be provided with an optical character reader (OCR) function.

The output device 230 includes a display 231, a speaker 232, and a printer 233. The display 231 displays a cursor, an icon, and a toolbox, and data such as a text, an image, and functional information. The speaker 232 outputs sounds such as sound effects and readout sounds. The printer 233 prints image and text data.

### [Functional Configuration of the Electronic Document Management Apparatus]

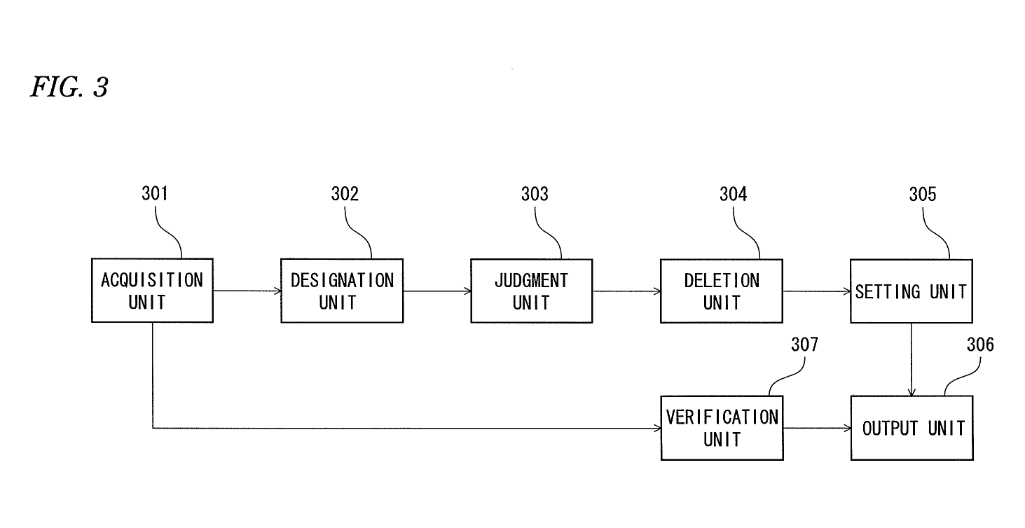

Now, a functional configuration of the electronic document management apparatus 101 of an embodiment of the present disclosure will be explained. FIG. 3 is a block diagram illustrating a functional configuration of an embodiment of the present disclosure. In FIG. 3, the electronic document management apparatus 101 includes an acquisition unit 301, a designation unit 302, a judgment unit 303, a deletion unit 304, a setting unit 305, an output unit 306, and a verification unit 307.

These units 301 to 307 can realize their functions by causing a CPU to execute corresponding programs stored in a storage area. Output data from functions 301 to 307 is retained in the storage area.

First, the acquisition unit 301 acquires an electronic document M comprised of a plurality of components to each of which a first digital signature and a second digital signature are uniquely specified, and the document M is linked to an aggregate digital signature of the first digital signatures of each component. The electronic document M is a generic name for documents processed on a computer and electronic data created, for example, by applications designed for creating documents.

Each component comprising the electronic document M has various states identified by a combination of the component, and first and second digital signatures specified for the component. More specifically, each component has either one of the following states:
(1) Hiding allowed and deletion allowed
(2) Hiding prohibited and deletion allowed
(3) Hiding prohibited and deletion prohibited
(4) Hiding allowed and deletion prohibited
(5) Already hidden and deletion prohibited
(6) Already hidden and deletion allowed
(7) Already deleted

For example, when one component is “hiding allowed and deletion allowed” a redactor can arbitrarily hide or delete this component. A “hiding” here means, for example, by applying sanitization, to change the state so that a reader cannot recognize the content. “Deletion” means to change the state so that the reader cannot recognize the existence of the content.

The electronic document M may be created at the electronic document management apparatus 101 or by other computer apparatus. When another computer creates the electronic document M, the acquisition unit 301 acquires the electronic document M from the other computer via a network 110 such as Internet.

The designation unit 302 provides a function to accept designation of a component to be “hiding prohibited” among the electronic document M acquired by an acquisition unit 301. More specifically, designation of a component to be “hiding prohibited” is accepted by the redactor's operation of the input unit 220 such as the keyboard 221 and the mouse 222 shown in FIG. 2.

The judgment unit 303 provides a function to judge whether the component is “hiding allowed and deletion allowed” or not, based on the existence of the component designated to be “hiding prohibited” by the designation unit 302, and the first and the second digital signatures specified for the component. This means the state of the component is identified by a combination of the component designated to be “hiding prohibited” and the first and the second digital signatures specified for the component. Whether the identified state is “hiding allowed and deletion allowed” or not is judged as well. The judgment unit 303 judges that the component is “hiding allowed and deletion allowed” when a component exists that is designated to be hiding prohibited, and first and second digital signatures exist that are specified for the component.

The deletion unit 304 provides a function to delete the second signature specified for the component designated to be “hiding prohibited”, when the judgment unit 303 judges that the state is “hiding allowed and deletion allowed”. More specifically, the deletion unit 304 deletes the second digital signature retained by being linked to the component designated to be “hiding prohibited” in a storage area such as a ROM or a RAM.

A setting unit 305 provides a function to change settings of the component subject to become “hiding prohibited” as a result of the deletion by the deletion unit 304 from “hiding allowed and deletion allowed” to “hiding prohibited and deletion allowed”. This means that the setting unit 305 sets the component to “hiding prohibited and deletion allowed” when a second digital signature specified for the component subject to be “hiding prohibited” with a state of “hiding allowed and deletion allowed” is deleted. As a result, the component in the state of “hiding allowed and deletion allowed” is designated to be “hiding prohibited” becomes “hiding prohibited and deletion allowed”, which means it can be deleted but cannot be hidden.

The designation unit 302 may accept a designation of a component in the document M to be “deletion prohibited”. In this case, the judgment unit 303 judges whether the component is “hiding prohibited and deletion allowed” or not based on the existence of the component designated to be “hiding prohibited” by the designation unit 302 and the first digital signature specified for the component. The judgment unit 303 judges the component to be “hiding prohibited and deletion allowed” when the component designated to be “hiding prohibited” and the first digital signature specified for the component exist.

The deletion unit 304 deletes the first digital signature specified for the component subject to be “deletion prohibited” from an aggregate digital signature and deletes the first digital signature specified for the component as well when the judgment unit 303 judges the component to be “hiding prohibited and deletion allowed”. More specifically, the unit 304 deletes the first digital signature specified for the component designated to be “deletion prohibited” from the aggregate digital signature retained by being linked to the electronic document M in a storage area and deletes the first digital signature retained by being linked to the component in the storage area.

The setting unit 305 may change the state of the component subject to become “deletion prohibited” as a result of the deletion by the deletion unit 304 from “hiding prohibited and deletion allowed” to “hiding prohibited and deletion prohibited”. As a result, the component the state of which is “hiding prohibited and deletion allowed” and designated to be “deletion prohibited” becomes “hiding prohibited and deletion prohibited” which cannot be hidden or deleted.

The designation unit 302 may accept a designation of a component to be deleted within the electronic document M. In this case, the judgment unit 303 judges whether the component is “hiding prohibited and deletion allowed” or not based on the existence of the component designated to be deleted by the designation unit 302 and the first digital signature specified for the component. The judgment unit 303 judges the component to be “hiding prohibited and deletion allowed” when the component designated to be deleted and the first digital signature specified for the component exist.

When the judgment unit 303 judges that the component is in a state of “hiding prohibited and deletion allowed”, the deletion unit 304 deletes the first digital signature specified for the component subject to be deleted from the aggregate digital signature and deletes the component and the first digital signature specified for the component as well. More specifically, the deletion unit 304 deletes the first digital signature specified for the component designated to be deleted from the aggregate digital signature retained by being linked to the electronic document M in a storage area, and deletes the first digital signature retained by being linked to the component in a storage area.

The setting unit 305 changes the state of the component subject to become deleted as a result of the deletion by the deletion unit 304 from “hiding prohibited and deletion allowed” to “already deleted”. As a result, the component the state of which is “hiding prohibited and deletion allowed” and designated to be “deleted” becomes “already deleted” and the component is deleted from the electronic document M.

The above designation of a component to be “hiding prohibited” and that of a component to be “deletion prohibited” and “deleted” may be conducted by different electronic document management apparatuses 101 respectively. This means that one electronic document management apparatus 101 can designate a component the state of which is “hiding allowed and deletion allowed” as a subject to be “hiding prohibited”. The other electronic document management apparatus 101 can designate a component the state of which is “hiding prohibited and deletion allowed” as a subject to be “deletion prohibited” or “deleted”.

The output unit 306 provides a function to output the electronic document M set by the setting unit 305. The output format of the output unit 306 may be either to an external computer apparatus (e.g., the electronic document management apparatuses and 103), print output to a printer 233, or data output (storage) to a memory.

The acquisition unit 301 provides a function to acquire a redacted document R to which the state of the component is set by the setting unit 305. The redacted document R is electronic data to which redaction to a component is applied. More specifically, for example, for a redacted document R, the state of the component designated to be “hiding prohibited” can be changed from “hiding allowed and deletion allowed” to “hiding prohibited and deletion allowed”.

The redacted document R is transmitted (output) from an electronic document management apparatus 101 used by the redactor to that used by a verifier when the verifier requests the redactor to disclose the document R. Then an acquisition unit 301 of the verifier's electronic document management apparatus 101 acquires the redacted document R transmitted from the redactor's electronic document management apparatus 101.

The verification unit 307 provides a function to verify authenticity of the redacted document R acquired by the acquisition unit 301 based on the first and the second digital signatures and the aggregate digital signatures. More specifically, the unit 307 verifies the authenticity of the redacted document R by decoding the first and the second digital signatures and the aggregate digital signatures using a public key of a signer.

The output unit 306 provides a function to output results verified by the verification unit 307. More specifically, the output unit 306 outputs verification results indicating verification passed when verifications of the first and the second digital signatures and the aggregate digital signature are all passed. On the other hand, the output unit 306 outputs verification results indicating verification failure when verifications of any of the first digital signature, the second digital signature or the aggregate digital signature fails.

The designation of a component to be “hiding prohibited”, “deletion prohibited”, and “deleted” by the designation unit 302 may be allowed for the component comprising the redacted document R acquired by the acquisition unit 301. This enables additional redactions to the electronic document M (or the redacted document R).

The electronic document management apparatus according to this embodiment can designate a subject for various redactions besides “hiding prohibited”, “deletion prohibited” and “deleted”, as above. For example, the designation unit 302 can accept the designation of a component to be hid within the electronic document M. In this case, the judgment unit 303 judges whether the component is “hiding allowed and deletion allowed” or not based on the existence of the component designated to be hid and the first and the second digital signatures specified for the component.

When the judgment reveals that the component is “hiding allowed and deletion allowed”, the component designated to be hid is replaced with a hash value of the component. Then the setting unit 305 changes the state of the component subject to be “hiding prohibited” from “hiding allowed and deletion allowed” to “already hidden and deletion allowed”. Specific processes when various redactions are designated will be explained later.

The acquisition unit 301 may acquire an electronic document M comprised of a plurality of components to each of which a first digital signature and a second digital signature are uniquely specified. In addition, the electronic document M is linked to a first aggregate digital signature of the first digital signatures and a second aggregate digital signature of the second digital signatures.

Here an electronic document M which can represent the following states by a different representation method (i.e., the second aggregation signature is added) from the above mentioned electronic document M is acquired:
(1) Hiding allowed and deletion allowed
(2) Hiding prohibited and deletion allowed
(3) Hiding prohibited and deletion prohibited
(4) Hiding allowed and deletion prohibited
(5) Already hidden and deletion prohibited
(6) Already hidden and deletion allowed
(7) Already deleted

The designation unit 302 accepts the designation of a component to be “hiding prohibited” among the electronic document M. The judgment unit 303 judges whether the state of the component designated to be “hiding prohibited” is “hiding allowed and deletion allowed” or not. When the judgment unit judges that the state is “hiding allowed and deletion allowed”, the deletion unit 304 deletes the second digital signature specified for the component subject to be hiding prohibited from the second aggregate digital signature and deletes the second digital signature specified for the component as well. The setting unit 305 changes the state of the component subject to “hiding prohibited” as a result of the deletion by the deletion unit from “hiding allowed and deletion allowed” to “hiding prohibited and deletion allowed”.

The designation unit 302 accepts a designation of a component to be “deletion prohibited”. The judgment unit 303 judges whether the state of the component designated to be “deletion prohibited” is “hiding prohibited and deletion allowed” or not. The deletion unit 304 deletes the first digital signature specified for the component subject to be “deletion prohibited” when the judgment unit 303 judges the state is “hiding prohibited and deletion allowed”. The setting unit 305 changes the state of the component subject to become “deletion prohibited” as a result of the deletion by the deletion unit 304 from “hiding prohibited and deletion allowed” to “hiding prohibited and deletion prohibited” when the deletion unit 304 deletes the first digital signature.

The designation unit 302 accepts a designation of a component to be deleted. The judgment unit 303 judges whether the state of the component designated to be “deleted” is “hiding prohibited and deletion allowed” or not. When the judgment unit 303 judges the state is “hiding prohibited and deletion allowed”, the deletion unit 304 deletes the first digital signature specified for the component subject to be “deleted” from the aggregated first signature and deletes the component and the first signature specified for the component. The setting unit 305 changes the state of the component subject to become “deleted” as a result of the deletion by the deletion unit 304 from “hiding prohibited and deletion allowed” to “already deleted”.

The acquisition unit 301 acquires a redacted document R to which the state of the component is set by the setting unit 305. Then a verification unit 307 may verify the authenticity of the redacted document R acquired by the acquisition unit 301 based on the first and the second digital signatures, and the first and the second aggregate digital signatures. Specific processes when various redactions are designated are explained in embodiments 2 and 3 later.

### [Processing Procedures of a Redaction by the Electronic Document Management Apparatus]

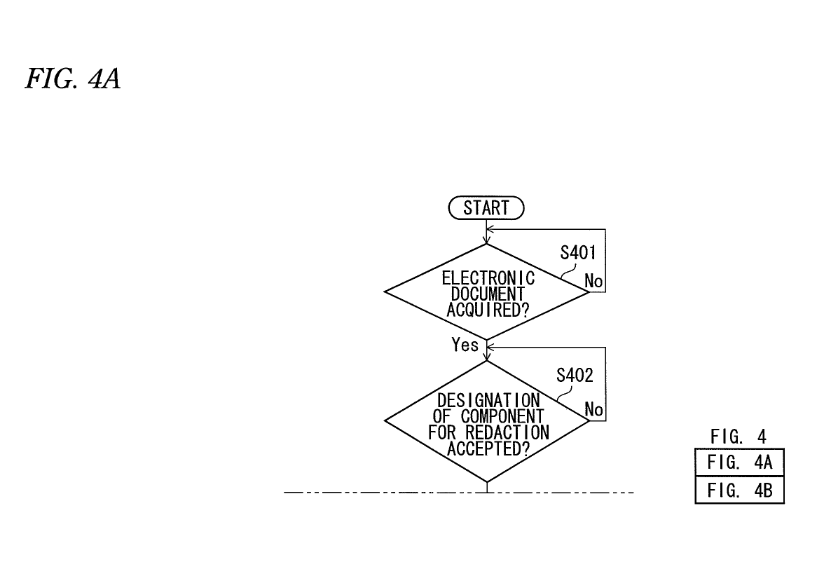

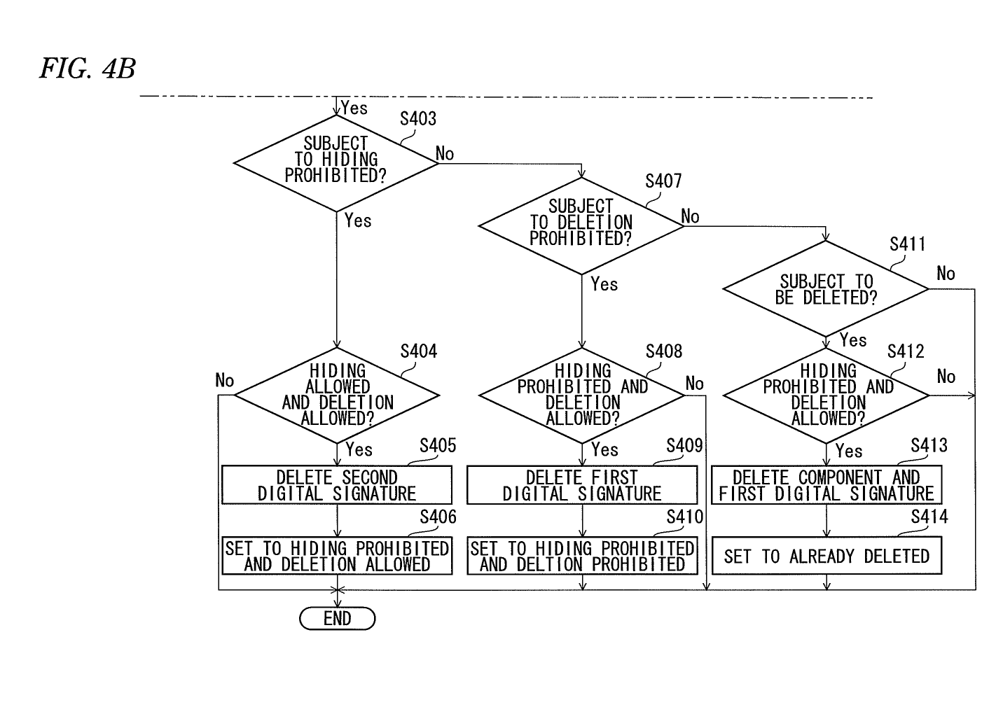

Now, processing procedures of a redaction by the electronic document management apparatus 101 is explained. FIG. 4 is a flow chart illustrating processing procedures for redaction by the electronic document management apparatus according to an embodiment.

In the flow chart of FIG. 4, whether or not a plurality of components in the electronic document M, to each of which a first and a second digital signatures are specified, the components being linked to a signature which aggregate the first digital signatures of each component, is acquired by the acquisition unit 301 is judged (Step S 401).

The electronic document management apparatus waits until the acquisition unit 301 acquires the electronic document M (Step S401: No). When the unit 301 acquires the document (Step S401: Yes), whether the designation of a component to be redacted is accepted by the designation unit 302 or not is judged (Step S402). After waiting for the designation (Step S402: No), when the designation is accepted (Step S402: Yes), whether or not the designation of a component to be “hiding prohibited” is accepted is judged (Step S403).

When designation of the component to be “hiding prohibited” is accepted (Step S403: Yes), the judgment unit 303 judges whether the state of the component is “hiding allowed and deletion allowed” or not based on the existence of the component designated to be “hiding prohibited” and the first and the second digital signatures specified for the component (Step S404).

When the judgment unit 303 judges that the state is “hiding allowed and deletion allowed” (Step S404:Yes), the deletion unit 304 deletes a second digital signature specified for the component subject to be “hiding prohibited” (Step S405). Then the setting unit 305 changes the settings of the component from “hiding allowed and deletion allowed” to “hiding prohibited and deletion allowed” (Step S406), thereby completing the process.

In Step S404, when the judgment reveals that the state is not “hiding allowed and deletion allowed” (Step S404: No), the process of this flow chart ends. In Step S403, when the designation of a component to be hiding prohibited is not accepted (Step S403: No), whether or not designation of a component to be “deletion prohibited” is accepted is judged (Step S407).

When designation of a component to be “deletion prohibited” is accepted (Step S407:Yes), the judgment unit 303 judges whether the component is “hiding prohibited and deletion allowed” or not based on the existence of the component designated to be “hiding prohibited” and the first digital signature specified for the component (Step S408).

When the judgment reveals that the state is “hiding prohibited and deletion allowed” (Step S408: Yes), the deletion unit 304 deletes the first digital signature specified for the component designated to be “deletion prohibited” (Step S409). Then a setting unit 305 changes the settings of the component subject to be “deletion prohibited” from “hiding prohibited and deletion allowed” to “hiding prohibited and deletion prohibited” (Step S410), thereby completing the process in this flow chart.

In step S408, when the judgment reveals that the state is not “hiding prohibited and deletion allowed” (Step S408: No), the process completes. In step S407, when designation of a component to be deletion prohibited is not accepted (Step S407: No), whether designation of a component to be deleted is accepted or not is judged (Step S411).

When designation of a component to be deleted is accepted (Step S411:Yes), the judgment unit 303 judges whether the state of the component is “hiding prohibited and deletion allowed” or not based on the existence of the component designated to be deleted and the first digital signature specified for the component (Step S412).

When the judgment reveals that the state is “hiding prohibited and deletion allowed” (Step S412:Yes), the deletion unit 304 deletes the first digital signature specified for the component subject to be deleted from aggregate digital signatures and deletes the component and the first digital signature specified for the component as well (Step S413).

Then the setting unit 305 changes the settings of the component subject to be deleted from “hiding prohibited and deletion allowed” to deleted (Step S414), thereby completes the process. When designation of a component to be deleted is not accepted at Step S411 (Step S411: No), or judgment reveals that “hiding prohibited and deletion allowed” at Step S412 (Step S412: No), the process ends.

This allows settings of “hiding prohibited and deletion allowed” for components in the electronic document M. Moreover, a component set to be “hiding prohibited and deletion allowed” can be set to “hiding prohibited and deletion prohibited”, or already deleted.

### [Processing Procedures of Verification by the Electronic Document Management Apparatus]

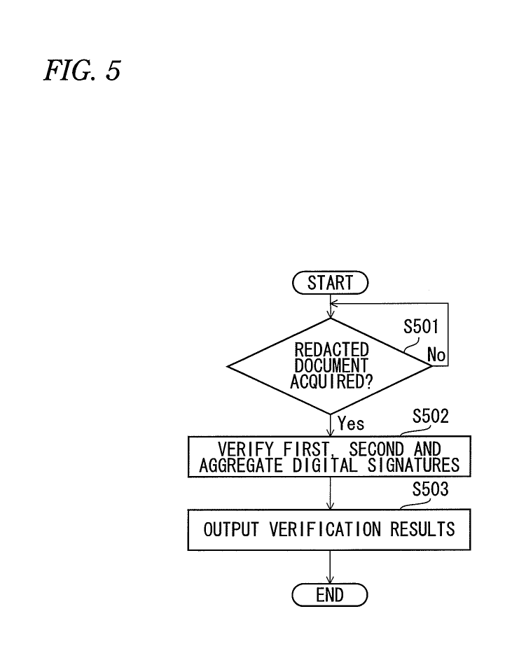

Now a verification procedure by the electronic document management apparatus 101 according to an embodiment is explained. FIG. 5 shows a flow chart illustrating a verification procedure of the electronic document management apparatus according to an embodiment. In the flowchart of FIG. 5, first, whether or not a redacted document R set by a setting unit 305 is acquired by an acquisition unit is judged (Step S501).

Now the electronic document management apparatus waits until the redacted document R is acquired (Step S501). Then a verification unit 307 verifies the authenticity of the redacted document R acquired by the reduction unit 301 based on the first and the second digital signatures and the aggregate digital signature (Step S502). Finally, an output unit 306 outputs the results verified by the verification unit 307 (Step S503), thereby completing the process.

Electronic document management apparatus 101 can change settings of the component of the electronic document M to “hiding prohibited and deletion allowed” while allowing verification of the authenticity of the electronic document M. Furthermore, the electronic document management apparatus 101 can change the state of the component set from “hiding prohibited and deletion allowed” to “hiding prohibited and deletion prohibited” or to “already deleted”.

### [States of a Partial Document and the State Transitions]

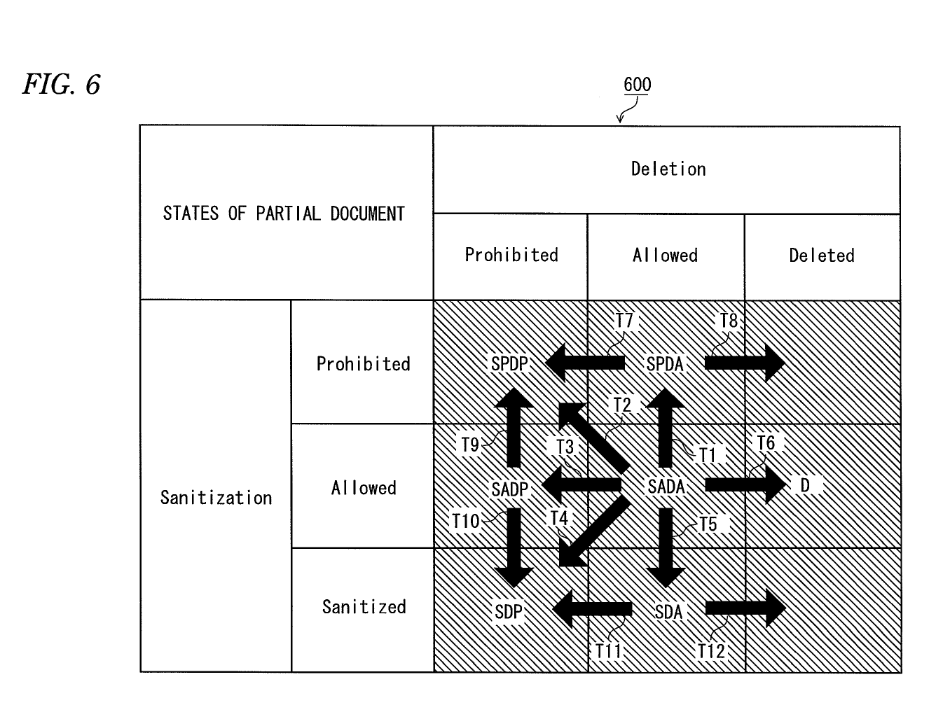

Now states of a partial document and the state transitions will be explained. FIG. 6 is a diagram illustrating states of a partial document and the state transitions. The partial document corresponds to a component in the above mentioned electronic document.

In FIG. 6, a diagram 600 illustrates states that can be set for each partial document in the electronic document M. More specifically, each state is represented by a combination of the following attributes regarding to Sanitization and Deletion: Prohibited, Allowed, and Sanitized or Deleted.

These states are described as follows respectively:
Sanitization Allowed and Deletion Allowed (SADA)
Sanitization Prohibited and Deletion Allowed (SPDA)
Sanitization Prohibited and Deletion Prohibited (SPDP)
Sanitization Allowed and Deletion Prohibited (SADP),
Sanitized and Deletion Allowed (SDA)
Sanitized and Deletion Prohibited (SDP) and
Deleted (D)

Transitions between these states are described in the diagram 600 as twelve states transitions from T1 to T12. These from T1 to T12 represent state transitions that can be set as a state for each partial document when a redactor redacts each partial document.

For example, the state transition T1 represents the transition from “Sanitization Allowed and Deletion Allowed” (SADA) to “Sanitization Prohibited and Deletion Allowed” (SPDA). The state transition T7 represents the transition from SPDA to “Sanitization Prohibited and Deletion Prohibited” (SPDP).

### [Summary of Generating a Digital Signature]

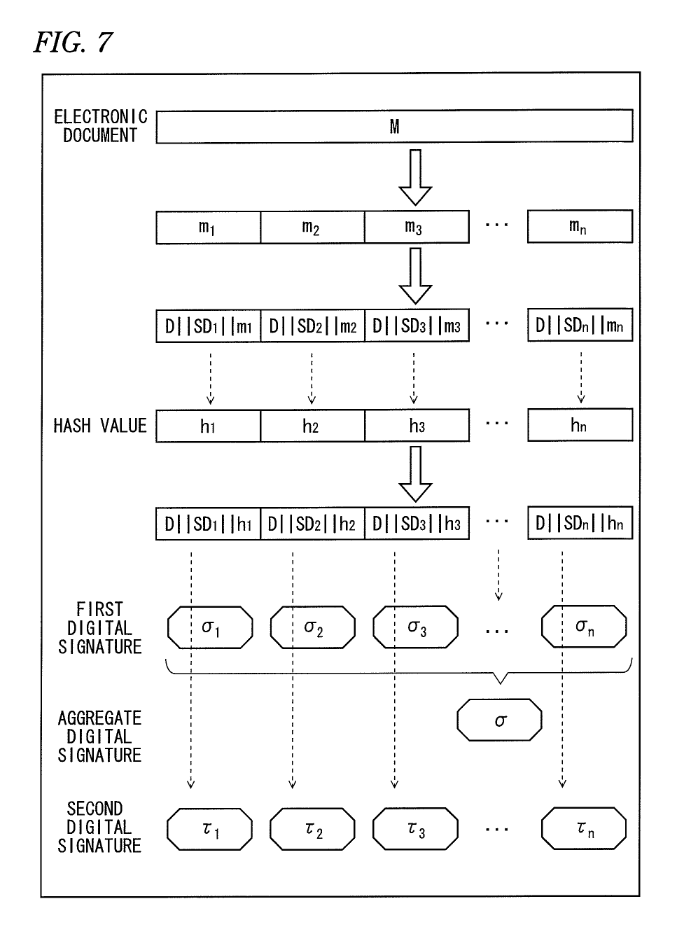

Now, a summary of generating a digital signature that is applied to an electronic document M will be explained. FIG. 7 is an explanatory diagram illustrating a summary of digital signature generation. In FIG. 7, first, the electronic document M is divided into the number of “n” partial documents, “m1, m2, . . . mn”. More specifically, the electronic document M may be divided from the top, for example, by the byte, the character, the word, the sentence, or the page.

After that, using random numbers, an unpredictable document ID and a partial document ID are assigned to each partial document from m1 to mn respectively. The document ID is a value common to all partial documents “m1, m2, . . . ,mn” comprising the electronic document M. Hereunder, the document ID is described as “D”.

The partial document ID is a value that varies depending on each partial document from m1 to mn. The partial document IDs are assigned to from m1 to mn so that the IDs are in ascending (or descending) order according to the order in which each partial document from m1 to mn appears. Hereunder, the partial document IDs assigned to each partial document from m1 to mn are described as “SD1, SD2, . . . , SDn” respectively. A partial document mi to which document ID and partial document ID are added is described as

“D∥SDi∥mi(i=1,2, . . . , n)”

After that, a hash value of “D∥SDi∥mi” is calculated for each “i”. More specifically, pseudo-random numbers with fixed-length are calculated from each partial document “D∥SDi∥mi” using a hash function. Hereunder the hash values for each partial document “D∥SDi∥mi” are described as “h1, h2, . . . , hn”.

After that, the document ID and the partial document ID assigned to partial documents from m1 to mn are assigned to corresponding hash values from h1 to hn. Hereunder, a hash value to which a document ID and a partial document ID are added are described as “D∥SDi∥hi (i=1,2, . . . , n)”.

For each i, a first digital signature for D//SDi//hi (i=1,2, . . . ,n) is generated using a signer's secret key. Hereunder, first digital signatures for each hash value “D//SDi//hi” are described as “σ1, σ2, . . . , σn”. (σ is Sigma)

Now, generations of signer's secret key and public key are explained. When a secret key and a public key are generated, first, bilinear map “e” to group G′ is generated from a prime number p with appropriate size, group G whose element number is p and the generation source g, group G′ which is different from group G whose element count is p, and G times G.

An unpredictable integer sk is determined from integers more than or equal to one and less or equal to p−1. Moreover, gsk is calculated and set as pk. As a result, a signer's secret key shall be sk and public key shall be pk respectively. Hereunder, a signer's secret key is described as “secret key sk”, while the public key is described as “public key pk”.

When first digital signatures from σ1 to σn are generated, a first digital signature σi=H (D∥SDi∥hi) is calculated for each i. A function H is a function to convert any value into a value of group G, and it is difficult to obtain the input value from the output value after conversion.

For details of key generation of the above secret key and public key, refer to the following.
Boneh, Gentry, Lynn, Shacham, “Aggregate and Verifiably Encrypted Signatures from Bilinear Maps”, Eurocrypt 2003, Lecture Notes in Computer Science (LNCS) Vol. 2656, pp. 416-432, 2003.

Now returning to the explanation of FIG. 7, after generation of the first digital signatures from σ1 to σn , an aggregate digital signature which aggregates the first digital signatures from σ1 to σn is calculated. More specifically, an aggregate digital signature σ may be calculated by multiplying each of the first digital signatures from a σ1 to σn. Hereunder, the aggregate digital signature which aggregates the first digital signatures from σ1 to σn is described as “σ”.

For each i, a second digital signature for partial document DS∥Di∥mi is generated using a signer's secret key sk. Hereunder the second digital signatures for the partial document D∥SDi∥mi are described as “τ1, τ2, . . . ,τn”. (τ is Tao)

For generating first and second digital signatures, methods such as RSA signature scheme and ESIGN signature based on factorization in prime numbers, ElGamal and DSA signatures based on discrete logarithm, and elliptic curve ElGamal and DSA signatures based on elliptic curve discrete logarithm may be used.

The above first digital signatures from σ1 to σn and second digital signatures from τ1 to τn are specified for each partial document “D∥SDi∥mi”. An aggregate digital signature σ which aggregates the first digital signature from σ1 to σn are linked to the electronic document M.

As stated above, specifying the first digital signature from σ1 to σn and second digital signature from τ1 to τn for each partial document “D∥SDi∥mi” and linking the aggregate digital signature σ with the electronic document M enables verification of the authenticity of the electronic document M (the redacted document R) when any redaction is made to each partial document “D∥SDi∥mi”.

### [Initial State of the Electronic Document M]

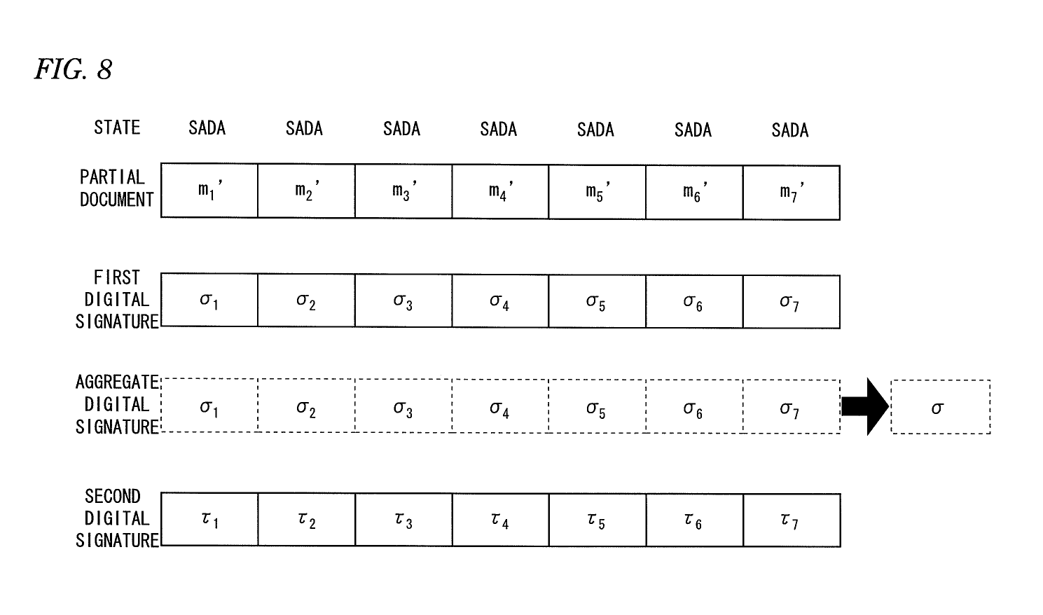

Now, an initial state of an electronic document M will be explained. FIG. 8 is an explanatory diagram illustrating an example of initial state of an electronic document M according to a first embodiment. Hereunder, a partial document “D∥SDi∥mi” to which a document ID and a partial document ID are added is described as “mi′”.

In FIG. 8, the electronic document M is divided into a plurality of documents from m1′ to m7′ . For each partial document from m1′ to m7′, corresponding first digital signatures from σ1 to σ7 and second digital signatures from τ1 to τ7 are specified. An aggregate digital signature σ which aggregates the first digital signatures from σ1 to σ7 is linked to the electronic document M. At an initial state of the electronic document M, the states of these partial documents from m1′ to m7′ are Sanitization Allowed and Deletion Allowed (SADA).

### [Method for Representing States of Partial Documents]

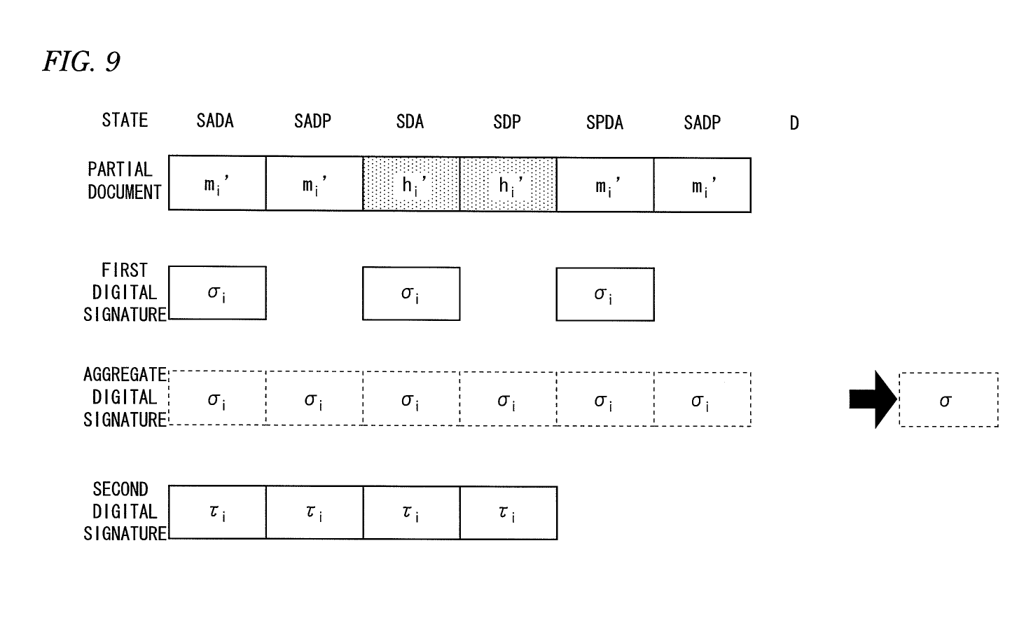

Now, a method for representing states of each partial document mi′ is explained. FIG. 9 is an explanatory diagram illustrating a method for representing states of partial documents according to the first embodiment. Hereunder, a hash value D∥SDi∥hi to which document ID and partial document ID are added are described as hi′. In FIG. 9, states of each partial document mi′ are represented by a combination of a partial document mi′, a hash value hi′, a first digital signature σi and a second digital signature τi.

First, “Sanitization Allowed and Deletion Allowed” (SADA), which is the initial state, is represented by a combination of a partial document mi′, a first digital signature σi and a second digital signature τi. In this case, an aggregate digital signature σ includes the first digital signature σi.

“Sanitization Allowed and Deletion Prohibited” (SADP) is represented by a combination of a partial document mi′ and the second digital signature τi. In this case the first digital signature σi is deleted from the aggregate digital signatures σ.

“Sanitized and Deletion Allowed” (SDA) is represented by a combination of a hash value hi′, the first digital signature σi and the second digital signature τi. In this case, the aggregate digital signature σ includes the first digital signature σi.

“Sanitized and Deletion Prohibited” (SDP) is represented by a combination of a hash value hi′, and the second digital signature τi. In this case, the first digital signature σi is deleted from the aggregate digital signature σ.

“Sanitization Prohibited and Deletion Allowed” (SPDA) is represented by a combination of a partial document mi′ and a first digital signature σi. Furthermore, “Sanitization Prohibited and Deletion Prohibited” (SPDP) is represented by a partial document mi′. In this case, the first digital signature σi is deleted from the aggregate digital signature σ.

“Deleted” (D) is represented by a combination of neither a partial document mi′, a hash value hi′, a first digital signature σi, or a second digital signature τi. In this case, the first digital signature σi is deleted from the aggregate digital signature.

### [Transitions Between States]

Now, state transitions from T1 to T12 shown in FIG. 6 are explained. The state transition T1 indicates a transition from SADA to SPDA. In order to enable this transition, a second digital signature τi specified for a partial document mi′ is deleted. However, the transition from SPDA to SADA is not allowed, because SPDA does not have the second digital signature τi.

The state transition T2 indicates the transition from SADA to SPDP. In order to enable this transition, a first digital signature σi and a second digital signature τi specified for a partial document mi′ are deleted. However, the transition from SPDP to SADA is not allowed, because SPDP does not have the first digital signature σi and the second digital signature τi.

The state transition T3 indicates the transition from SADA to SADP. In order to enable this transition, a first digital signature σi specified for a partial document mi′ is deleted. However, the transition from SADP to SADA is not allowed, because SADP does not have the first digital signature σi.

The state transition T4 indicates the transition from SADA to SDP. In order to enable this transition, a partial document mi′ is replaced with a hash value hi′ and a first digital signature σi specified for the partial document is deleted. However, the transition from SDP to SADA is not allowed, because in SDP, a partial document mi′ is replaced with a hash value hi′ and obtaining the partial document mi′ from the hash value hi′ is not allowed.

The state transition T5 indicates the transition from SADA to SDA. In order to enable this transition, a partial document mi′ is replaced with a hash value hi′. However, the transition from SDA to SADA is not allowed, because in the SDA, a partial document mi′ is replaced with a hash value hi′ and obtaining the partial document mi′ from the hash value hi′ is not allowed.

The state transition T6 indicates the transition from SADA to D. In order to enable this transition, a first digital signature σi specified for a partial document mi′ is deleted from an aggregate digital signature σ, and the partial document mi′, the first digital signature σi and the second digital signature τi specified for the partial document are deleted as well. However, the transition from D to SADA is not allowed, because the D does not have the partial document mi′ and the first digital signature σi and the second digital signature τi specified for the partial document mi′.

The state transition T7 indicates the transition from SPDA to SPDP. In order to enable this transition, the first digital signature σi specified for a partial document mi′ is deleted. However, the transition from SPDP to SPDA is not allowed, because SPDP does not have the first digital signature σi.

A transition from SPDP to SDP is not allowed, because SPDP does not have a second digital signature τi. The transition from SPDP to D is not allowed as well, because SPDP does not have a first digital signature σi, and the first digital signature σi specified for the partial document mi cannot be deleted from the aggregate digital signature

The state transition T8 indicates the transition from SPDA to D. In order to enable this transition, a first digital signature σi specified for a partial document mi′ is deleted from the aggregate digital signature σ, the partial document mi′ and the first digital signature σi specified for the partial document are deleted as well.

A transition from D to SPDA is not allowed, because D does not have a partial document mi′ and a first digital signature σi specified for the partial document mi′. The transition from SPDA to SDA is not allowed as well, because SPDA does not have the second digital signature τi.

The state transition T9 indicates the transition from SADP to SPDP. In order to enable this transition, a second digital signature τi specified for a partial document mi′ is deleted. However, the transition from SPDP to SADP is not allowed, because SPDP does not have the second digital signature τi.

The state transition T10 indicates the transition from SADP to SDP. In order to enable this transition, a partial document mi′ is replaced with a hash value hi′. However, the transition from SDP to SADP is not allowed, because in SDP, a partial document mi′ is replaced with a hash value hi′ and obtaining the partial document mi′ from the hash value hi′ is not allowed.

A transition from SDP to D is not allowed, because SDP does not have a first digital signature σi and the first digital signature σi specified for the partial document mi′ cannot be deleted from the aggregate digital signature σ.

The state transition T11 indicates the transition from SDA to SDP. In order to enable this transition, a first digital signature σi specified for a partial document mi′ is deleted. However, the transition from SDP to SDA is not allowed, because SDP does not have the first digital signature σi.

The state transition T12 indicates the transition from SDA to D. In order to enable this transition, a first digital signature σi specified for a partial document mi′ is deleted from the aggregate digital signature σ and a hash value hi′ and the first digital signature and the second digital signature specified for the partial document mi′ are all deleted as well. However, the transition from D to SDA is not allowed, because D does not have a hash value and the first digital signature σi and the second digital signature τi specified for the partial document mi′.

Now referring to the electronic document M shown in FIG. 8, specific examples of state transitions from T1 to T12 are explained. For example, in order to transit the state of a partial document m3′ of partial documents from m1′ to m7′ from SADA to SPDA (state transition T1), the second digital signature τ3 specified for the partial document m3′ is deleted.

After that, in order to transit state of partial document m3′ from SPDA to SPDP (the state transition T7), the first digital signature σ3 specified for the partial document m3′ is deleted. In order to transit the state of partial document m3′ from SADA to SDA (the state transition T5), the partial document m3′ is replaced with a hash value h3′.

When a partial document mi′ is replaced with a hash value hi′ in the state transitions T4, T5, and T10, a subscript assigned to this partial document mi′ is added to a subscript set S. The enables to determination of which partial document mi′ is sanitized by referring to the subscript set S.

The above subscripts are pre-assigned to a first digital signature σi and a second digital signature τi specified for the partial document mi′ and retained in a storage area by being linked to each partial document mi′. Subscripts are newly assigned upon completion of redaction of electronic document M, and the subscripts retained in the subscript set S are updated as well.

For example, assume that an electronic document M is comprised of partial documents from m1′ to m7′, and subscripts from 1 to 7 are assigned to each of the partial documents respectively. When a partial document m7′ is sanitized, a subscript 7 is added to the subscript set S. When a partial document m6′ is deleted, a subscript is reassigned upon completion of the redaction, and the subscript of the partial document becomes 6. In this case, the subscript retained in the subscript set S is updated from 7 to 6.

### Processing Procedures of Redaction

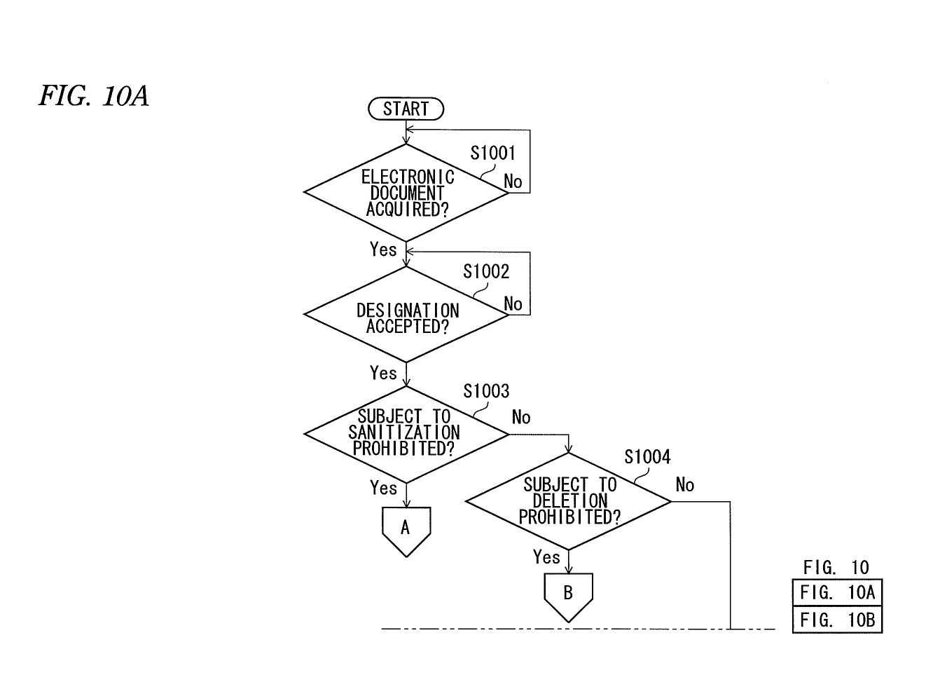

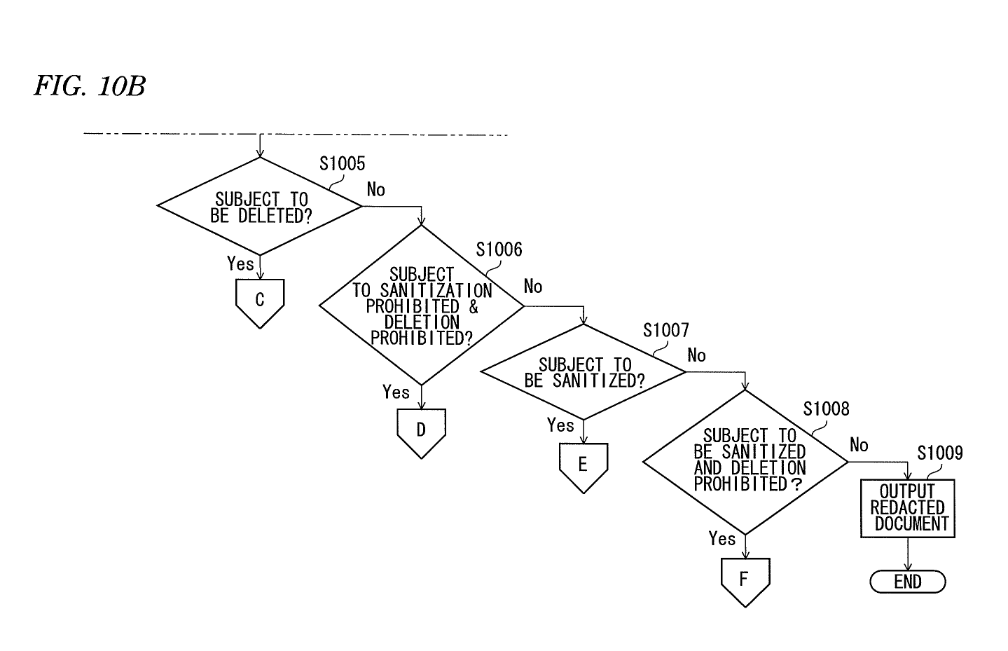

Processing procedures of a redaction according to the first embodiment is explained. FIGS. 10 to 16 are flow charts illustrating processing procedures of a redaction according to the first embodiment. In a flow chart of FIG. 10, whether an electronic document M comprised of a plurality of partial documents from m1′ to mn′ are acquired by an acquisition unit 301 or not is judged (Step S1001). More specifically, for example, the electronic document M shown in FIG. 8 is obtained.

The electronic document management apparatus waits until acquisition unit 301 acquires the electronic document M (Step S1001: No), and when the document is acquired (Step S1001: Yes), determines whether or not a designation unit 302 accepts the designation of a subject to be redacted (Step S1002). After waiting for the designation (Step S1002: No), when the designation is accepted (Step S1002: Yes), whether the designation of a subject to be “sanitization prohibited” is accepted or not is judged (Step S1003).

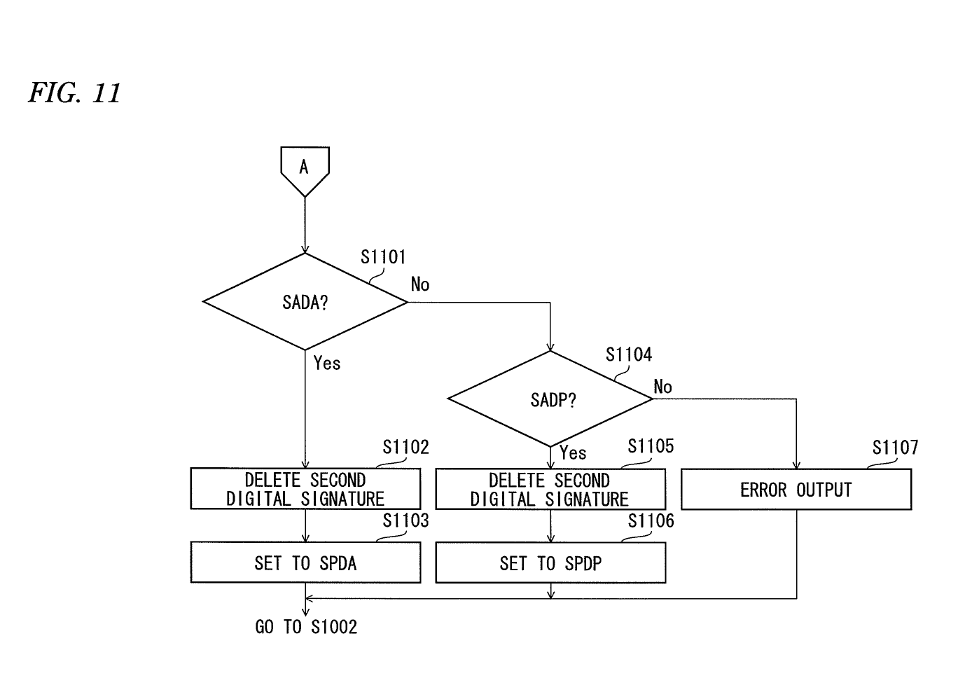

When the designation of a subject to be “sanitization prohibited” is accepted (Step S1003: Yes), the flow proceeds to step S1101 shown in FIG. 11. When the designation of sanitization prohibited is not accepted (Step S1003: No), the judgment unit 303 judges whether designation of a subject to be “deletion prohibited” is accepted or not (Step S1004).

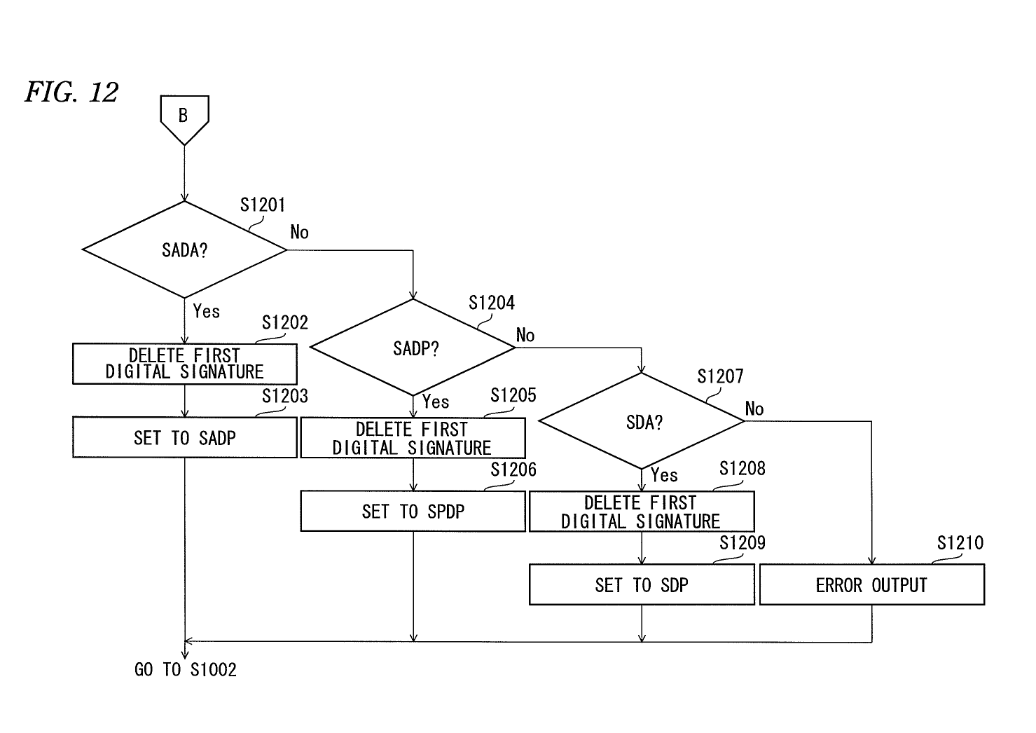

When designation of a subject to be deletion prohibited is accepted (Step S1004: Yes), the flow proceeds to step S1201 shown in FIG. 12. When the designation of a subject to be “deletion prohibited” is not accepted (Step S1004: No), the judgment unit judges whether designation of a subject to be “deleted” is accepted or not (Step S1005).

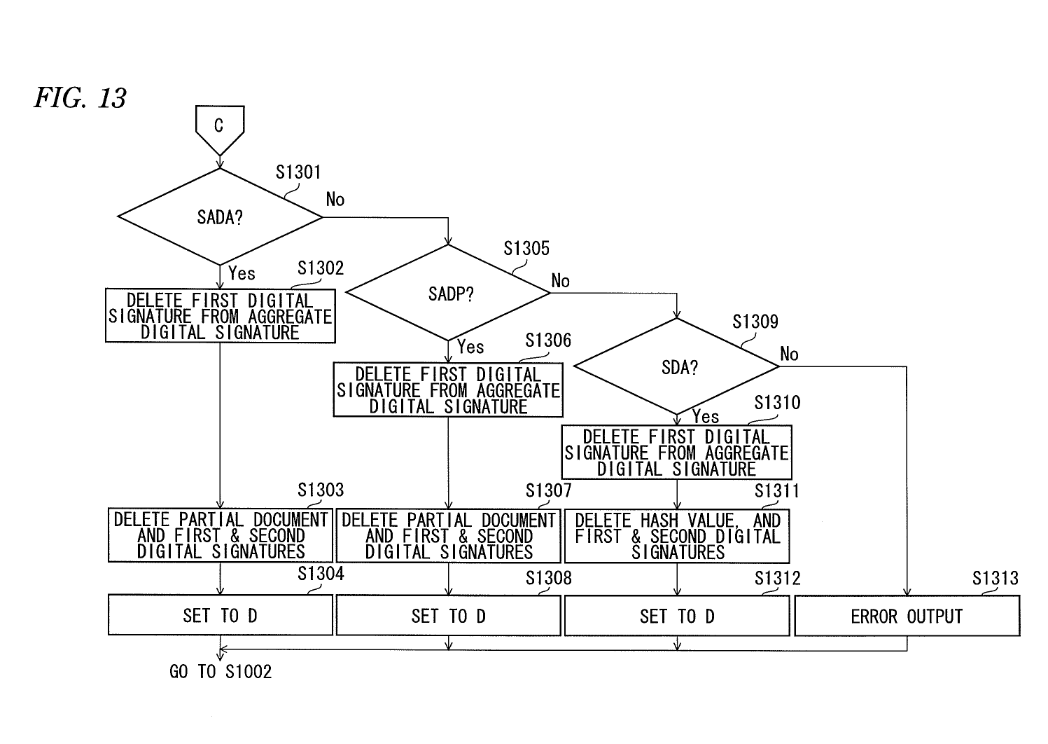

When designation of a subject to be “deleted” is accepted (Step S1005: Yes), the flow proceeds to step S1301 shown in FIG. 13. When the designation of a subject to be “deleted” is not accepted (Step S1005: No), the judgment unit 303 judges whether designation of a subject to be “sanitization prohibited and deletion prohibited” is accepted or not (Step S1006).

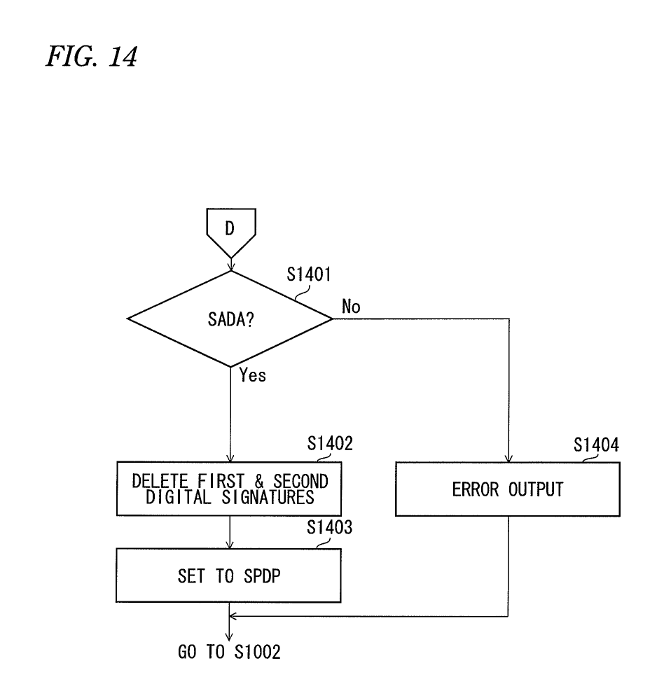

When the judgment unit 303 judges designation of a subject to be “sanitization prohibited and deletion prohibited” is accepted (Step S1006: Yes), the flow proceeds to step S1401 shown in FIG. 14. When the judgment unit 303 judges such designation is not accepted (Step S1006:No), the judgment unit 303 further judges whether designation of a subject to be “sanitized” is accepted or not (Step S1007).

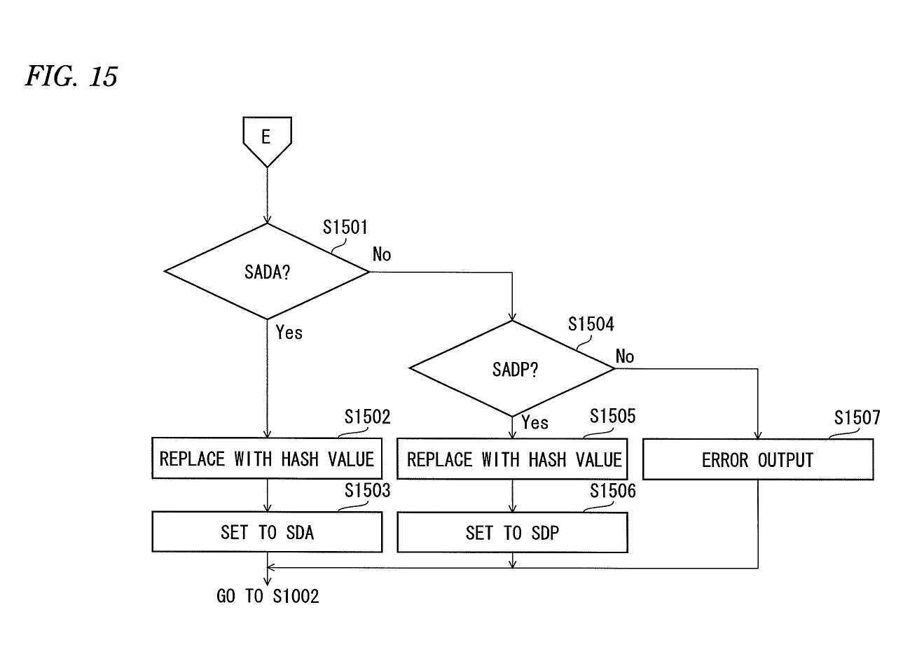

When the judgment unit 303 judges designation of a subject to be “sanitized” is accepted (Step S1007: Yes), the flow proceeds to step S1501 shown in FIG. 15. When the judgment unit 303 judges such designation is not accepted (Step S1007: No), the unit 303 judges whether designation of a subject to be “sanitized and deletion prohibited” is accepted or not (Step S1008).

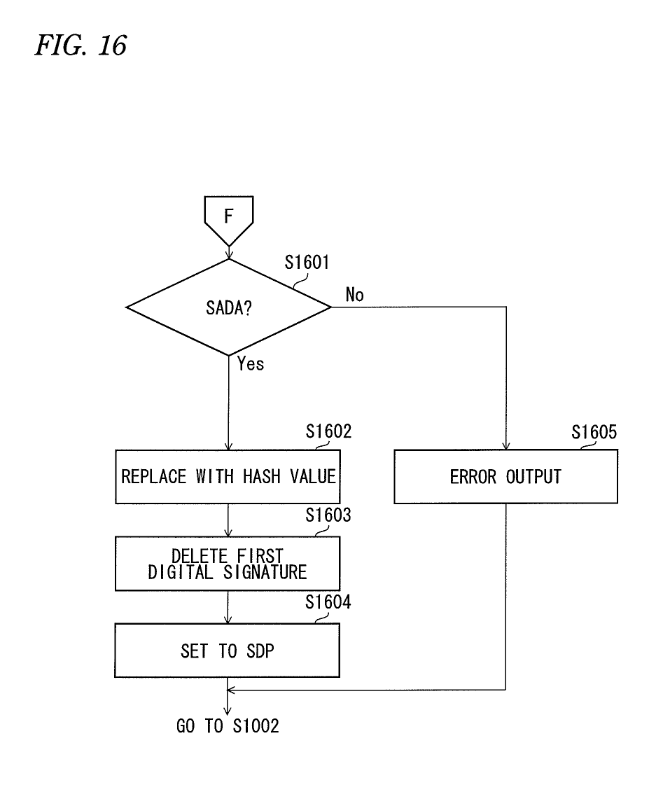

When designation of a subject to be “sanitized and deletion prohibited” is accepted (Step S1008: Yes), the flow proceeds to step S1601 shown in FIG. 16. When such designation is not accepted (Step S1008:No), the judgment unit 303 judges that designation indicating completion of the redaction is accepted, and an output unit 306 outputs the redacted document R (Step S1009), thereby completing a series of processes by this flow chart.

The designation indicating completion of redaction is accepted as in the same manner as that of redaction, for example by a redactor's operation of an input apparatus such as a keyboard 221, and a mouse 222 shown in FIG. 2. The electronic document M acquired at Step S1001 may be a redacted document R to which the redaction process has already been applied.

In a flow chart of FIG. 11, the judgment unit 303 judges whether a state of a partial document mi′ which is designated to be “sanitization prohibited” is SADA or not (Step S1101). When the state is SADA (Step S1101:Yes), the deletion unit 304 deletes the second digital signature τi specified for the partial document mi′ which is designated to be “sanitization prohibited” (Step S1102).

After that, a setting unit 305 changes the state of the partial document mi′ which is designated to be “sanitization prohibited” from SADA to SPDA (Step S1103), and returns to step S1002 shown in FIG. 10. When the state is not SADA in Step 1101 (Step S1101: No), the judgment unit 303 judges whether the state of the partial document mi′ designated to be sanitization prohibited is SADP or not (Step S1104).

When the state is SADP (Step S1104:Yes), the deletion unit 304 deletes the second digital signature τi specified for the partial document mi′ designated to be “sanitization prohibited” (Step S1105). Then a setting unit 305 changes the state of the partial document mi′ designated to be “sanitization prohibited” from SADP to SPDP (Step S1106), and the flow returns to step S1002 shown in FIG. 10.

When the state is not SADP at Step S1104 (Step S1104: No), an output unit 306 outputs an error notifying that the partial document mi′ which cannot be designated to be “sanitization prohibited” is designated (Step S1107). Then the flow returns to the Step S1002 shown in FIG. 10.

In a flow chart of FIG. 12, first the judgment unit 303 judges whether the state of the partial document mi′ designated to be “deletion prohibited” is SADA or not (Step S1201). When the state is SADA (Step S1201:Yes), the deletion unit 304 deletes the first digital signature σi specified for the partial document mi which is designated to be “deletion prohibited” (Step S1202).

Then a setting unit 305 changes the state of the partial document mi′ designated to be “deletion prohibited” from SADA to SADP (Step S1203), and the flow returns to step S1002 shown in FIG. 10. When the state is not SADA at step S1201 (Step S1201:No), the judgment unit 303 judges whether the state of partial document mi′ designated to be “Deletion Prohibited” is SPDA or not (Step S1204).

When the state is SPDA (Step S1204:Yes), the deletion unit 304 deletes the first digital signature σi specified for the partial document mi′ which is designated to be “deletion prohibited” (Step S1205). Then a setting unit 305 changes the state of the partial document mi′ designated to be “deletion prohibited” from SPDA to SPDP (Step S1206), and the flow returns to step S1002 shown in FIG. 10.

When the state is not SPDA at step S1204 (Step S1204: No), the judgment unit 303 judges whether the state of partial document mi′ designated to be “deletion prohibited” is SDA or not (Step S1207). When the state is SDA (Step S1207:Yes), the deletion unit 304 deletes the first digital signature σi specified for the partial document mi′ which is designated to be “deletion prohibited” (Step S1208).

Then a setting unit 305 changes the state of the partial document mi′ which is designated to be “deletion prohibited” from SDA to SDP (Step S1209), and the flow returns to step S1002 shown in FIG. 10. When the state is not SDA at step S1207 (Step S1207: No), the output unit 306 outputs an error notifying that the partial document mi′ which cannot be designated to be “deletion prohibited” is designated (Step S1210). Then the flow returns to the Step S1002 shown in FIG. 10.

In a flow chart of FIG. 13, the judgment unit 303 judges whether a state of a partial document mi′ designated to be deleted is SADA or not (Step S1301). When the state is SADA (Step S1301:Yes), the deletion unit 304 deletes the first digital signature σi specified for the partial document mi′ which is designated to be “deleted” from the aggregate digital signature σ (Step S1302).

Then, the deletion unit 304 deletes the partial document mi′ designated to be deleted, the first digital signature σi and the second digital signature τi specified for the partial document mi′ (Step S1303). Then a setting unit 305 changes the state of the partial document mi′ designated to be deleted from SADA to D (Step S1304), and the flow returns to step S1002 shown in FIG. 10.

When the state is not SADA at step S1301 (Step S1301: No), the judgment unit 303 judges whether the state of partial document mi′ designated to be deleted is SPDA or not (Step S1305). When the state is SPDA (Step S1305:Yes), the deletion unit 304 deletes the first digital signature σi specified for the partial document mi′ from the aggregate digital signature σ (Step S1306).

Then, the deletion unit 304 deletes the partial document mi′ designated to be deleted, the first digital signature σi and the second digital signature τi specified for the partial document mi′ (Step S1307). Then a setting unit 305 changes the state of the partial document mi′ designated to be deleted from SPDA to D (Step S1308), and the flow returns to Step S1002 shown in FIG. 10.

When the state is not SPDA at step S1305 (Step S1305: No), the judgment unit 303 judges whether the state of the partial document mi′ designated to be deleted is SDA or not (Step S1309). When the state is SDA (Step S1309:Yes), the deletion unit 304 deletes the first digital signature σi specified for the partial document mi′ from the aggregate digital signature σ (Step S1310).

Then, the deletion unit 304 deletes a hash value hi′ specified for the partial document mi′ designated to be deleted, the first digital signature σi and the second digital signature τi specified for the partial document mi′ (Step S1311). Then a setting unit 305 changes the state of the partial document mi′ designated to be “deleted” from SDA to D (Step S1312), and the flow returns to step S1002 shown in FIG. 10.

When the state is not SDA at step S1309 (Step S1309: No), the output unit 306 outputs an error notifying that the partial document mi′ which cannot be designated to be “deleted” is designated (Step S1313). Then the system returns to the Step S1002 shown in FIG. 10.

In a flow chart of FIG. 14, the judgment unit 303 judges whether a state of a partial document mi′ designated to be “sanitization prohibited and deletion prohibited” is SADA or not (Step S1401). When the state is SADA (Step S1401:Yes), the deletion unit 304 deletes the first digital signature σi and the second digital signature τi specified for the partial document mi′ which is designated to be “sanitization prohibited and deletion prohibited” (Step S1402).

Then a setting unit 305 changes the state of the partial document mi′ which is designated to be “sanitization prohibited and deletion prohibited” from SADA to SPDP (Step S1403), and the flow returns to step S1002 shown in FIG. 10. When the state is not SADA at step S1401 (Step S1401: No), the output unit 306 outputs an error notifying that the partial document mi′ which cannot be designated to be “sanitization prohibited and deletion prohibited” is designated (Step S1404). Then the flow returns to the Step S1002 shown in FIG. 10.

In a flow chart of FIG. 15, the judgment unit 303 judges whether a state of a partial document mi′ which is designated to be “sanitization prohibited” is SADA or not (Step S1501). When the state is SADA (Step S1501: Yes), the partial document mi′ designated to be “sanitized” is replaced with a hash value hi′ (Step S1502).

Then a setting unit 305 changes the state of the partial document mi′ designated to be “sanitized” from SADA to SDA (Step S1503), and the flow returns to step S1002 shown in FIG. 10. When the state is not SADA at step S1501 (Step S1501: No), the judgment unit 303 judges whether a state of a partial document mi′ designated to be “sanitized” is SADP or not (Step S1504).

When the state is SADP (Step S1504: Yes), the partial document mi′ designated to be “sanitized” is replaced with a hash value hi′ (Step S1505). Then a setting unit 305 changes the state of the partial document mi′ designated to be “sanitized” from SADP to SDP (Step S1506), and the flow returns to step S1002 shown in FIG. 10.

When the state is not SADP at step S1504 (Step S1504: No), the output unit 306 outputs an error notifying that the partial document mi′ which cannot be designated to be “sanitized” is designated (Step S1507). Then the flow returns to the Step S1002 shown in FIG. 10.

In a flow chart of FIG. 16, the judgment unit 303 judges whether a state of a partial document mi′ designated to be “sanitized and deletion prohibited” is SADA or not (Step S1601). When the state is SADA (Step S1601: Yes), the partial document mi′ designated to be “sanitized and deletion prohibited” is replaced with a hash value hi′ (Step S1602).

Then, the deletion unit 304 deletes the first digital signature σi specified for the partial document mi′ designated to be “sanitized and deletion prohibited” (Step S1603). Then a setting unit 305 changes the state of the partial document mi′ designated to be “sanitized and deletion prohibited” from SADA to SDP (Step S1604), and the flow returns to step S1002 shown in FIG. 10.

When the state is not SADA at step S1601 (Step S1601: No), an output unit 306 outputs an error notifying that the partial document mi′ which cannot be designated to be “sanitized and deletion prohibited” is designated (Step S1605). Then the flow returns to Step S1002 shown in FIG. 10.

### [Summary of Verification Process]

Now, a summary of verification process for verifying the authenticity of a redacted document R in the first embodiment is explained. Normally, implementing the above redaction process applies an authentic redaction to each partial document from m1′ to mn′. However, an unauthorized redactor may apply unauthorized redaction.

For example, the partial document mi′ designated to be “sanitization prohibited” may be forcibly sanitized, or that designated to be “deletion prohibited” may be forcibly deleted. Then the authenticity of the redacted document R is verified by applying the verification process to the redacted document R. In this embodiment, hereunder, each partial document comprising the redacted document R is described as from X1 to Xn.

Now, using a signer's public key pk, authenticity of the redacted document R is verified by verifying first digital signatures from σ1 to σn and second digital signatures from τ1 to τn specified for each partial document, and the aggregate digital signature a linked with the redacted document R.

More specifically, a hash value Hi for each partial document from X1 to τi to Xn is obtained using a function H by referring to a subscript set S. When a subscript i is included in the subscript set S, Hi=mi′. When the subscript i is not included in the subscript set S, Hi=H(D∥SD∥hi). This means that for an unsanitized partial document mi′ a hash value is obtained using a function H.

Then a first digital signature σi is verified. More specifically, whether the expression below is true or not for the first digital signature σi is judged, and only when it is true, verification is judged to be passed.

e(σi, g)=e(Hi,pk) (1)

Then an aggregate digital signature σ is verified. More specifically, whether the expression below is true or not for the aggregate digital signature σ is judged, and only when it is true, the verification is judged to be passed. Please note that for the right side of the expression (2) below, all Hi correspond to first digital signatures included in an aggregate digital signature σ are applied.

e(σ, g)={e(Hi,pk)× . . . } (2)

For example, when the first digital signatures included in aggregate digital signature are σ1, σ2, and σ3, then H1, H2, and H3 correspond to each first digital signature from σ1 to σ3 are applied for the right side of above expression (2). This means the following expression is applied:

e(σ, g)={e(H1, pk)×e(H2, pk)×e(H3, pk)}

Then, a second digital signature τi is verified. More specifically, a verification expression of the digital signature algorithm applied when the second digital signature τi was generated is used. This means that for the second digital signature τi , whether the verification expression applied when the second digital signature τi was generated is true or not is judged, and only when it is true, verification is judged to be passed.

As mentioned above, the first digital signature σi, the second digital signature τi, and the aggregate digital signature σ are verified, and when all of the verifications are passed, the redacted document R is judged to be authenticated. However, the redacted document R is judged to be inappropriate even if just one of the verifications for the first digital signature σi, the second digital signature τi or aggregate digital signature σ failed.

### [Processing Procedures of Verification]

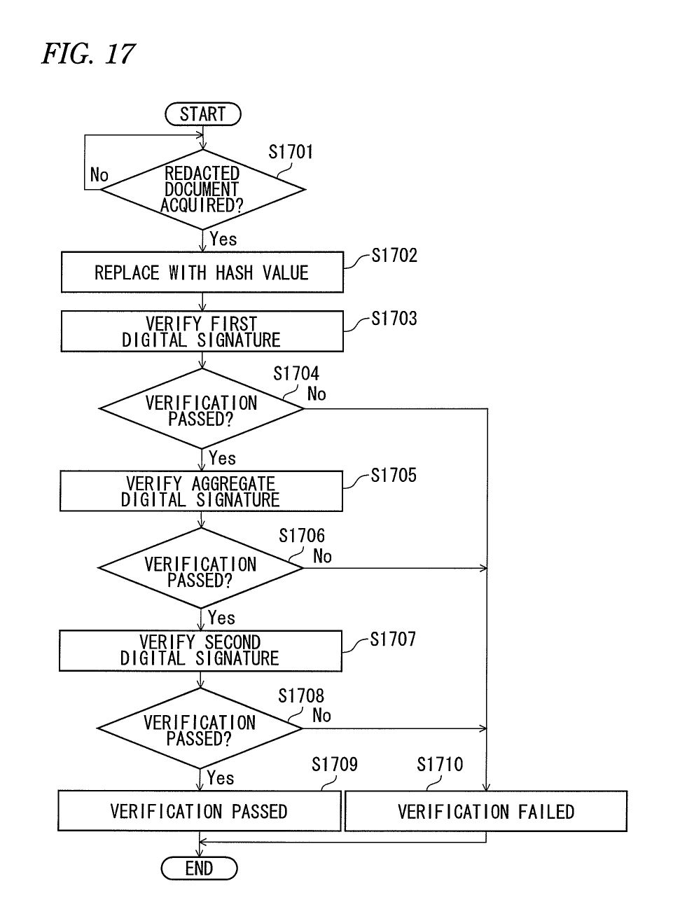

Now, processing procedures of verification by an electronic document management apparatus 101 according to the first embodiment is explained. FIG. 17 is a flow chart illustrating processing procedures of verification by the electronic document management apparatus according to the first embodiment. In FIG. 17, whether an acquisition unit 301 acquired a redacted document R or not is judged (Step S1701). More specifically, for example, the acquisition unit 301 acquires a redacted document R comprised of the above partial documents from X1 to Xn.

Now, the electronic document management apparatus waits for acquisition of the redacted document R (Step S1701: No), and when the document R is acquired (Step S1701: Yes), hash values Hi for partial documents from X1 to Xn are calculated by referring to a subscript set S. Then partial documents from X1 to Xn are replaced with hash values from H1 to Hn (Step S1702).

After that a verification unit 307 verifies a first digital signature σi for each i (Step S1703). Then the verification result of the first digital signature σi is judged (Step S1704), and when the verification passed (Step S1704:Yes), the verification unit 307 verifies an aggregate digital signature σ (Step S1705).

Then, the verification result of an aggregate digital signature σ is judged (Step S1706) and when the verification passed (Step S1706:Yes), the verification unit 307 verifies the second digital signature τi for each i (Step S1707).

Then the verification result of the second digital signature τi is judged (Step S1708), and when the verification passed (Step S1708:Yes), an output unit 306 outputs the results indicating that verification of the redacted document R is passed (Step S1709), thereby completes a series of processes by this flow chart.

When either one of the verifications at Step S1704, S1706, or S1708 failed (Step S1704, S1706, S1708: No), the output unit 306 outputs the results indicating that verification of the redacted document R failed (Step S1710), thereby completing a series of processes by this flow chart.

According to the above explained first embodiment, for the partial document mi′ comprising the electronic document M, either one of the following states can be set: SADA, SADP, SDA, SDP, SPDA, SPDP, or D. For transitions between these states, the state transitions from T1 to T12 can be realized.

In this embodiment, usability of a redactor is improved by realizing more flexible redactions of the electronic document M that allows setting seven states including “Sanitization Prohibited and Deletion Allowed” (SPDA). Moreover, this embodiment can guarantee authenticity of the electronic document M by retaining the state that allows verification of authenticity even if a redaction is applied to the electronic document M.

This embodiment improves flexibility in selecting an algorithm to generate a signature, because an ordinary digital signature scheme without an aggregation function is used for generation and verification of the second digital signature τi specified for each partial document mi′.

### Second Embodiment

Now, a second embodiment is explained. The second embodiment represents states of each the partial document mi′ in a different method from that of the first embodiment. Please note that explanations similar to that explained in the first embodiment are not shown and explained in the second embodiment.

### [Initial State of the Electronic Document M]

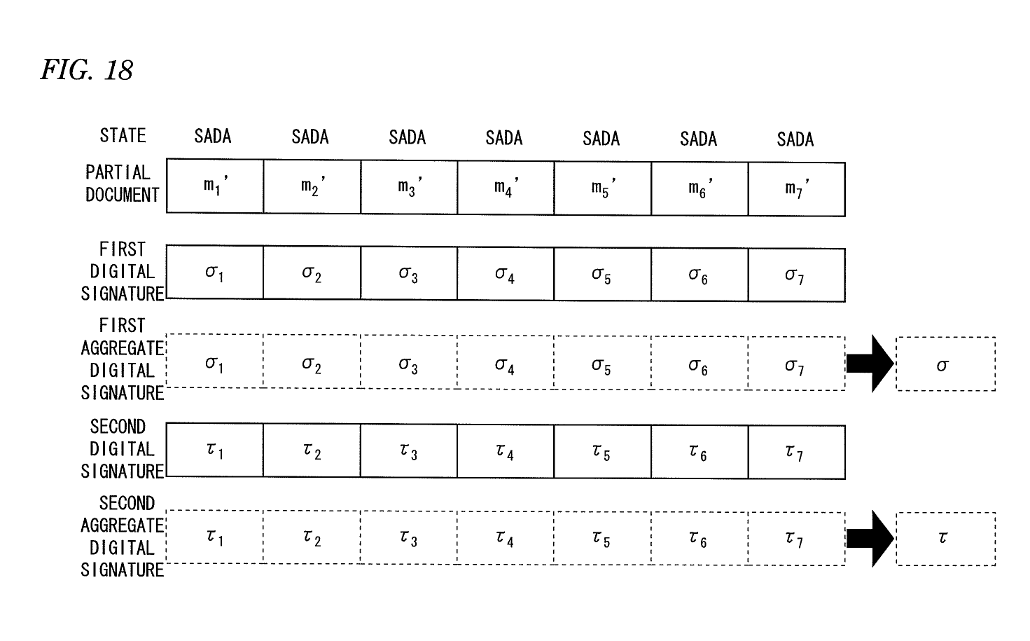

An initial state of the electronic document M will be explained. FIG. 18 is an explanatory diagram illustrating an example of an initial state of an electronic document M according to the second embodiment. In FIG. 18, the electronic document M is divided into a plurality of partial documents from m1′ to m7′. For each partial document from m1′ to m7′, corresponding the first digital signatures from σ1 to σ7 and the second digital signatures from τ1 to τ7 are specified.

An aggregate digital signature σ which aggregates the first digital signatures from σ1 to σ7 and the aggregate digital signature τ which aggregates the second digital signatures from τ1 to τ7 are linked to the electronic document M. In the initial state of the electronic document M, the states of these partial documents from m1′ to m7′ are SADA which is “Sanitization Allowed and Deletion Allowed”.

### [Method for Representing States of Each Partial Document]

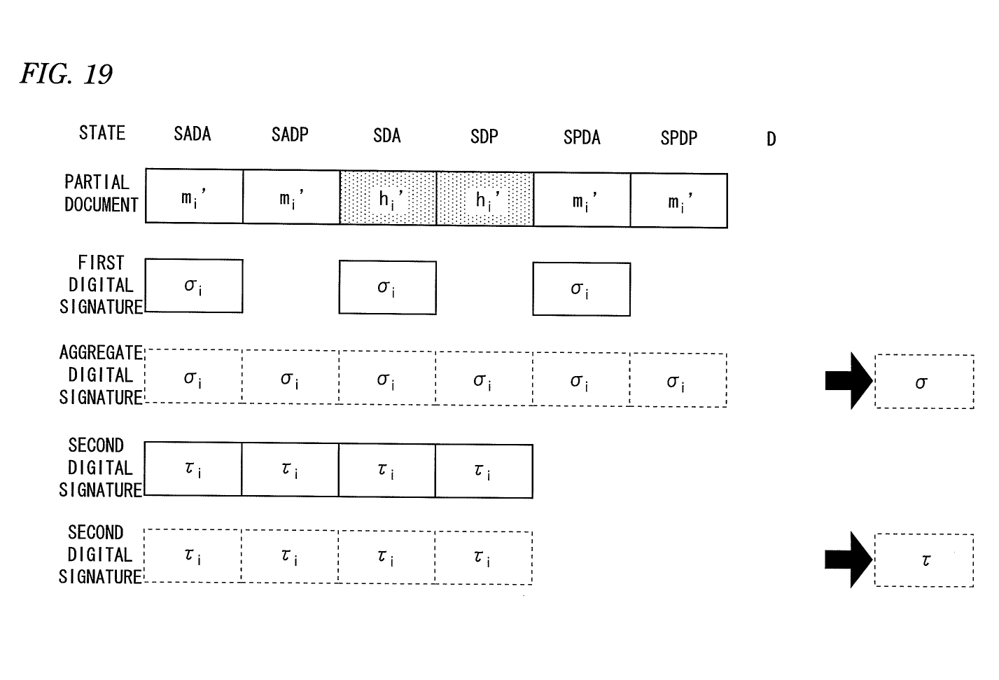

A method for representing states of each partial document mi′ is explained. FIG. 19 is an explanatory diagram illustrating a method for representing states of partial documents according to the second embodiment. In FIG. 19, states of each partial document mi′ are represented by a combination of the partial document mi′, the hash value hi′, the first digital signature σi and a second digital signature τi.

First, “Sanitization Allowed and Deletion Allowed” (SADA) is represented by a combination of the partial document mi′, the first digital signature σi and a second digital signature τi. In this case, an aggregate digital signature σ includes the first digital signature σi and the aggregate digital signature τ includes the second digital signature τi.

“Sanitization Allowed and Deletion Prohibited” (SADP) is represented by a combination of the partial document mi′ and the second digital signature τi. In this case the first digital signature σi is deleted from the aggregate digital signature σ.

“Sanitized and Deletion Allowed” (SDA) is represented by a combination of the hash value hi′, the first digital signature σi and the second digital signature τi. In this case, the aggregate digital signature σ includes the first digital signature σi and an aggregate digital signature τ includes the second digital signature τi. Sanitized and a Deletion Prohibited (SDP) is represented by a hash value hi′ and the second digital signature τi.

“Sanitization Prohibited and Deletion Allowed” (SPDA) is represented by a combination of a partial document mi′ and a first digital signature σi. In this case the second digital signature τi is deleted from the aggregate digital signature τ.

“Sanitization Prohibited and Deletion Prohibited” (SPDP) is represented by the partial document mi′. In this case, the first digital signature σi is deleted from the aggregate digital signature σ and the second digital signature τi is deleted from the aggregate digital signature τ.

“Deleted” (D) is represented by a combination of the absence of partial document mi′, the hash value hi′, the first digital signature σi, and a second digital signature τi. In this case the first digital signature σi is deleted from the aggregate digital signature σ and the second digital signature τi is deleted from the aggregate digital signature τ.

### [Processing Procedures of Redaction]

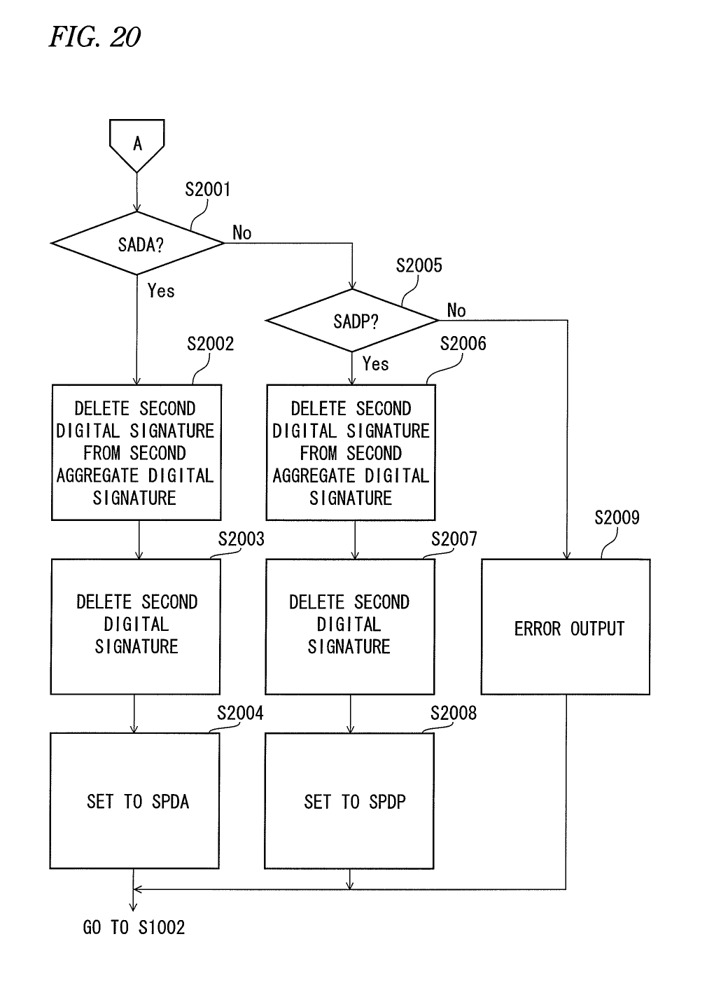

Processing procedures of a redaction according to the second embodiment will be explained. FIGS. 20 to 22 are flow charts illustrating processing procedures of a redaction according to the second embodiment. Please note that processing similar to that explained in the first embodiment are not shown and explained in the second embodiment (e.g. steps shown in FIGS. 10, 12, 15 and 16). Note that the electronic document M acquired at Step S1001 shown in FIG. 10 is, for example, an electronic document M shown in FIG. 18.

In FIG. 20, the judgment unit 303 judges whether a state of a partial document mi′ designated to be “sanitization prohibited” is SADA or not (Step S2001). When the state is SADA (Step S2001:Yes), the deletion unit 304 deletes the second digital signature τi that is specified for the partial document mi′ designated to be sanitization prohibited from the second aggregate digital signature τ. (Step S2002).

The deletion unit 304 deletes the second digital signature τi specified for the partial document mi′ which is designated to be “sanitization prohibited” (Step S2003). Then a setting unit 305 changes the state of the partial document mi′ which is designated to be “sanitization prohibited” from SADA to SPDA (Step S2004), and returns to step S1002 shown in FIG. 10.

When the state is not SADA at Step 2001 (Step S2001: No), the judgment unit 303 judges whether the state of partial document mi′ designated to be “sanitization prohibited” is SADP or not (Step S2005). When the state is SADP (Step S2005:Yes), the deletion unit 304 deletes the second digital signature τi specified for the partial document mi′ which is designated to be “sanitization prohibited” from the second aggregate digital signature τ (Step S2006).

Then the deletion unit 304 deletes the second digital signature τi specified for the partial document mi′ which is designated to be “sanitization prohibited” (Step S2007). Then the setting unit 305 changes the state of the partial document mi′ which is designated to be “sanitization prohibited” from SADP to SPDP (Step S2008), and the flow returns to step S1002 shown in FIG. 10.

When the state is not SADP at step S2005 (Step S2005: No), the output unit 306 outputs an error notifying that the partial document mi′ which cannot be designated to be “sanitization prohibited” is designated (Step S2009). Then the flow returns to the Step S1002 shown in FIG. 10.

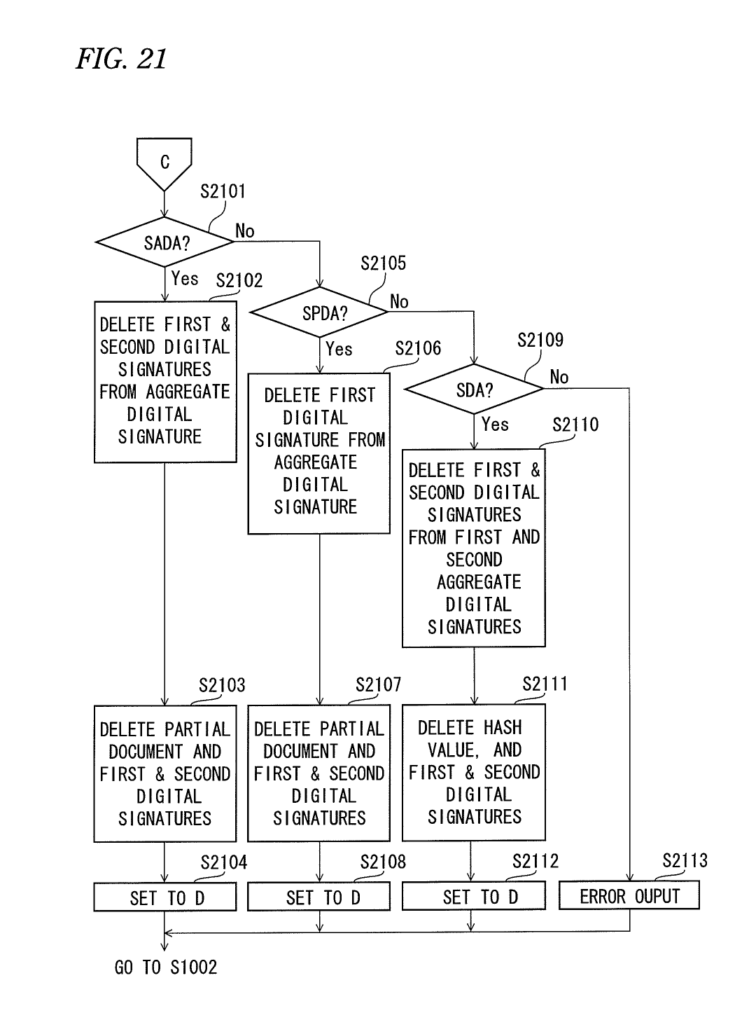

In a flow chart of FIG. 21, the judgment unit 303 judges whether a state of a partial document mi′ which is designated to be “deleted” is SADA or not (Step S2101). When the state is SADA (Step S2101:Yes), the deletion unit 304 deletes the first digital signature σi and the second digital signature τi specified for the partial document mi′ designated to be “deleted” from the aggregate digital signature σ and τ respectively (Step S2102).

Then, the deletion unit 304 deletes the partial document mi′ designated to be “deleted”, the first digital signature σi and the second digital signature τi specified for the partial document mi′ (Step S2103). Then the setting unit 305 changes the state of the partial document mi′ designated to be “deleted” from SADA to D (Step S2104), and the flow returns to step S1002 shown in FIG. 10.

When the state is not SADA at Step S2101 (Step S2101: No), the judgment unit 303 judges whether the state of partial document mi′ designated to be “deleted” is SPDA or not (Step S2105). When the state is SPDA (Step S2105:Yes), the deletion unit 304 deletes the first digital signature σi specified for the partial document mi′ from the aggregate digital signature σ (Step S2106).

Then, the deletion unit 304 deletes the partial document mi′ designated to be “deleted”, the first digital signature σi and the second digital signature τi specified for the partial document mi′ (Step S2107). Then the setting unit 305 changes the state of the partial document mi′ designated to be deleted from SPDA to D (Step S2108), and the flow returns to step S1002 shown in FIG. 10.

When the state is not SPDA at Step S2105 (Step S2105: No), the judgment unit 303 judges whether the state of partial document mi′ designated to be “deleted” is SDA or not (Step S2109). When the state is SDA (Step S2109:Yes), the deletion unit 304 deletes the first digital signature σi and the second digital signature τi specified for the partial document mi′ designated to be deleted from the aggregate digital signature σ and τ respectively (Step S2110).

Then, the deletion unit 304 deletes a hash value hi′ of the partial document mi′ designated to be deleted, and the first digital signature σi and the second digital signature τi specified for the partial document mi′ (Step S2111). Then a setting unit 305 changes the state of the partial document mi′ designated to be “deleted” from SDA to D (Step S2112), and the flow returns to step S1002 shown in FIG. 10.

When the state is not SDA at step S2109 (Step S2109: No), the output unit 306 outputs an error notifying that the partial document mi′ which cannot be designated to be “deleted” is designated (Step S2121). Then the flow returns to the Step S1002 shown in FIG. 10.

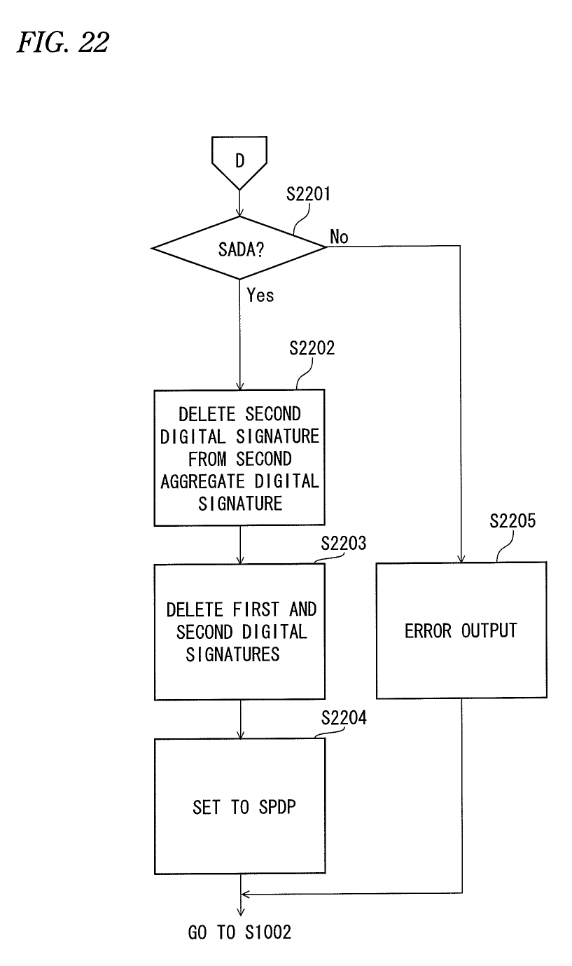

In FIG. 22, first the judgment unit 303 judges whether a state of a partial document mi′ designated to be “sanitization prohibited and deletion prohibited” is SADA or not (Step S2201). When the state is SADA (Step S2201:Yes), the deletion unit 304 deletes the second digital signature τi that is specified for the partial document mi′ designated to be “deleted” from the aggregate digital signature τ. (Step S2002).

After that the deletion unit 304 deletes the first digital signature σi and the second digital signature τi specified for the partial document mi′ which is designated to be “sanitization prohibited and deletion prohibited” (Step S2203). Then a setting unit 305 changes the state of the partial document mi′ designated to be “sanitization prohibited and deletion prohibited” from SADA to SPDP (Step S2204), and the flow returns to step S1002 shown in FIG. 10.

When the state is not SADA at step S2201 (Step S2201: No), the output unit 306 outputs an error notifying that the partial document mi′ which cannot be designated to be “sanitization prohibited and deletion prohibited” is designated (Step S2205). Then the flow returns to the Step S1002 shown in FIG. 10.

The verification process in the second embodiment is the same as the verification process in FIG. 17, but in addition, a step to verify an aggregate digital signature τ which aggregates the second digital signatures from τ1 to τn is also performed. When verifications of the first and the second digital signatures, the aggregate digital signature are all passed, results indicating the verification of redacted document R passed is output.

According to the second embodiment, for a partial document mi′ in an electronic document M, either one of the following states can be set: SADA, SADP, SDA, SDP, SPDA, SPDP, or D. For transitions between these states, the state transitions from T1 to T12 can be realized.

This embodiment provides regularity for a method to retain data to represent each state of a partial document (i.e., a combination of partial document mi′, a hash value hi′, a first digital signature σi, a second digital signature τi, a first aggregate digital signature σ, and a second aggregate digital signature τ). Thus contents of the redaction process have regularity as well, and a program to realize the second embodiment can be written with a simple description.

### Third Embodiment

Now, a third embodiment will be explained. The third embodiment represents states of each partial document mi′ in a different method from that of the embodiments 1 and 2. Please note that explanations similar to that explained in the embodiments 1 and 2 are not shown and explained in the third embodiment.

### [Method for Representing States of Partial Documents]

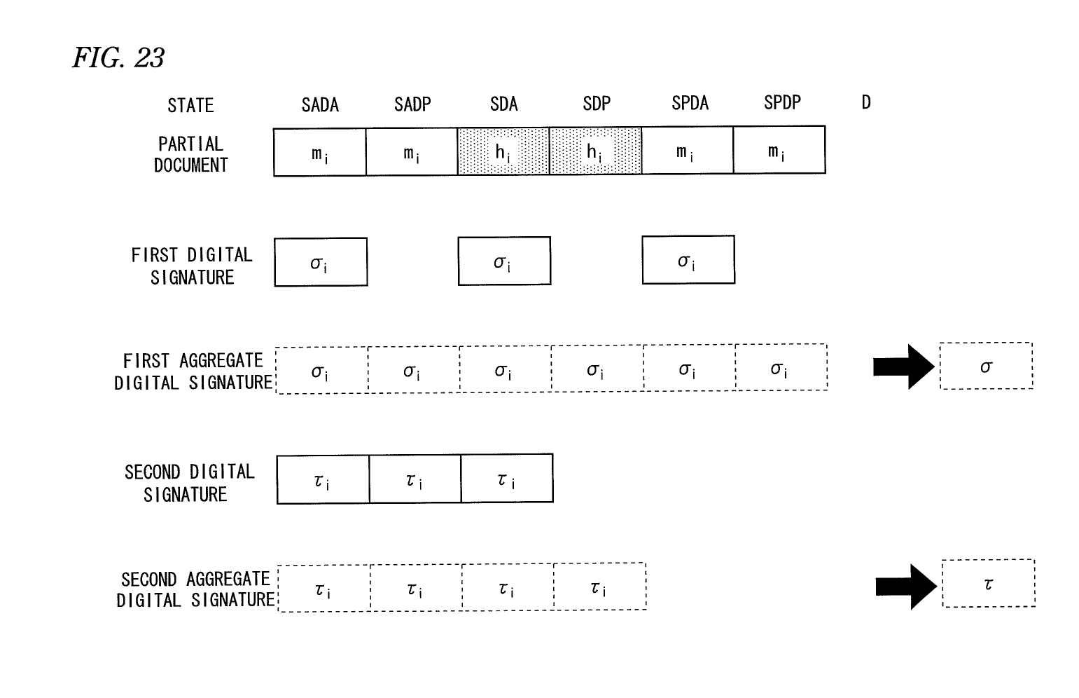

FIG. 23 is an explanatory diagram illustrating a method for representing states of partial documents according to an third embodiment. In FIG. 23, states of each partial document mi′ are represented by a combination of a partial document mi′, a hash value hi′, a first digital signature σi and a second digital signature τi.

Among methods to represent states of a partial document in the third embodiment shown in FIG. 23, only SDP differs from those in the second embodiment. More specifically, SDP, which is “Sanitized and Deletion Prohibited”, is represented by a hash value hi′.

### [Processing Procedures of Redaction]

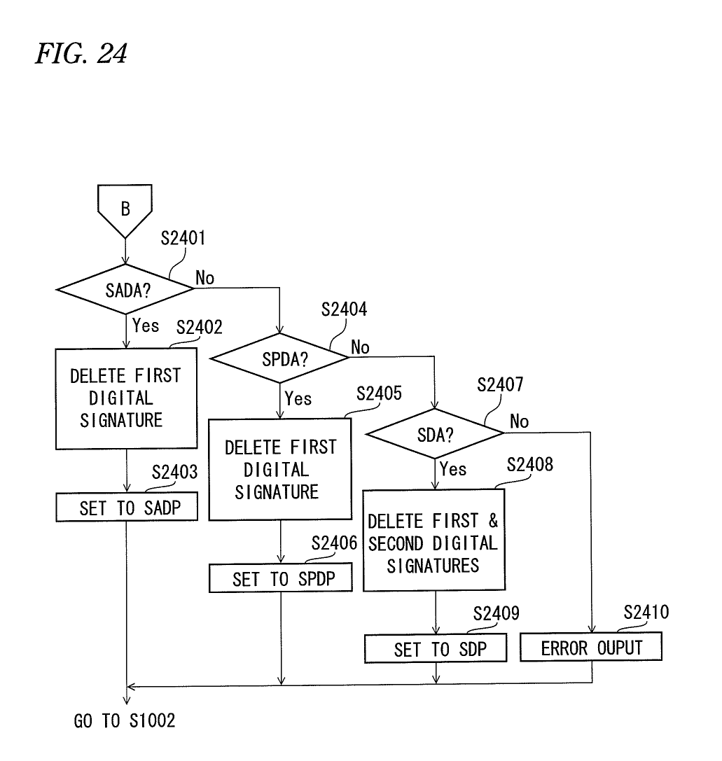

Processing procedures for redaction according to the third embodiment is explained. FIGS. 24 to 26 are flow charts illustrating processing procedures of redaction according to the third embodiment. The same processing as the first embodiment and second embodiment omit explaining in the third embodiment (e.g. steps shown in FIG. 10 and FIGS. 20 to 22). Note that the electronic document M acquired at Step S1001 shown in FIG. 10 is, for example, an electronic document M shown in FIG. 18.

In a flow chart of FIG. 24, first the judgment unit 303 judges whether the state of a partial document mi′ designated to be “deletion prohibited” is SADA or not (Step S2401). When the state is SADA (Step S2401:Yes), the deletion unit 304 deletes the first digital signature σi that is specified for the partial document mi′ designated to be “deletion prohibited” (Step S2402).

Then a setting unit 305 changes the state of the partial document mi′ which is designated to be “deletion prohibited” from SADA to SADP (Step S2403), and the flow returns to Step S1002 shown in FIG. 10. When the state is not SADA at Step S2401 (Step S2401: No), the judgment unit 303 judges whether the state of partial document mi′ designated to be “deletion prohibited” is SPDA or not (Step S2404).

When the state is SPDA (Step S2404:Yes), the deletion unit 304 deletes the first digital signature σi specified for the partial document mi′ designated to be “deletion prohibited” (Step S2405) Then a setting unit 305 changes the state of the partial document mi′ designated to be “deletion prohibited” from SPDA to SPDP (Step S2406), and the flow returns to Step S1002 shown in FIG. 10.

When the state is not SPDA at Step S2404 (Step S2404: No), the judgment unit 303 judges whether the state of the partial document mi′ designated to be “deletion prohibited” is SDA or not (Step S2407). When the state is SDA (Step S2407:Yes), the deletion unit 304 deletes the first digital signature σi and the second digital signature τi that are specified for the partial document mi′ designated to be “deletion prohibited” (Step S2408).

Then a setting unit 305 changes the state of the partial document mi′ designated to be “deletion prohibited” from SDA to SDP (Step S2409), and the flow returns to Step S1002 shown in FIG. 10. When the state is not SDA at step S2407 (Step S2407: No), the output unit 306 outputs an error notifying that the partial document mi′ which cannot be designated to be “deletion prohibited” is designated (Step S2410). Then the flow returns to Step S1002 shown in FIG. 10.

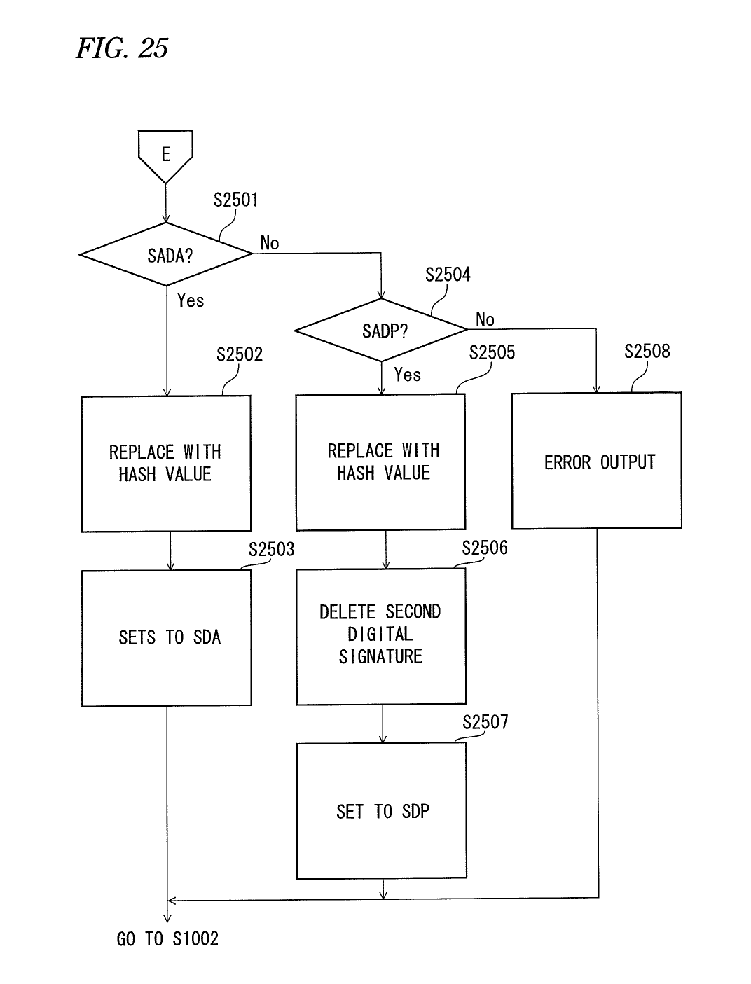

In a flow chart of FIG. 25, first, the judgment unit 303 judges whether a state of a partial document mi′ designated to be “sanitized” is SADA or not (Step S2501). When the state is SADA (Step S2501: Yes), the partial document mi′ designated to be “sanitized” is replaced with a hash value hi′ (Step S2502).

Then a setting unit 305 changes the state of the partial document mi′ designated to be “sanitized” from SADA to SDA (Step S2503), and the flow returns to step S1002 shown in FIG. 10. When the state is not SADA at Step S2501 (Step S2501: No), the judgment unit 303 judges whether the state of partial document mi′ designated to be “sanitized” is SADP or not (Step S2504).

When the state is SADP (Step S2504: Yes), the partial document mi′ designated to be “sanitized” is replaced with a hash value hi′ (Step S2505). After that the deletion unit 304 deletes the second digital signature τi specified for the partial document mi′ designated to be “sanitized” (Step S2506). Then a setting unit 305 changes the state of the partial document mi′ designated to be “sanitized” from SADP to SDP (Step S2507), and the flow returns to step S1002 shown in FIG. 10.

When the state is not SADP at Step S2504 (Step S2504: No), the output unit 306 outputs an error notifying that the partial document mi′ which cannot be designated to be sanitized is designated (Step S2508). Then the flow returns to the Step S1002 shown in FIG. 10.

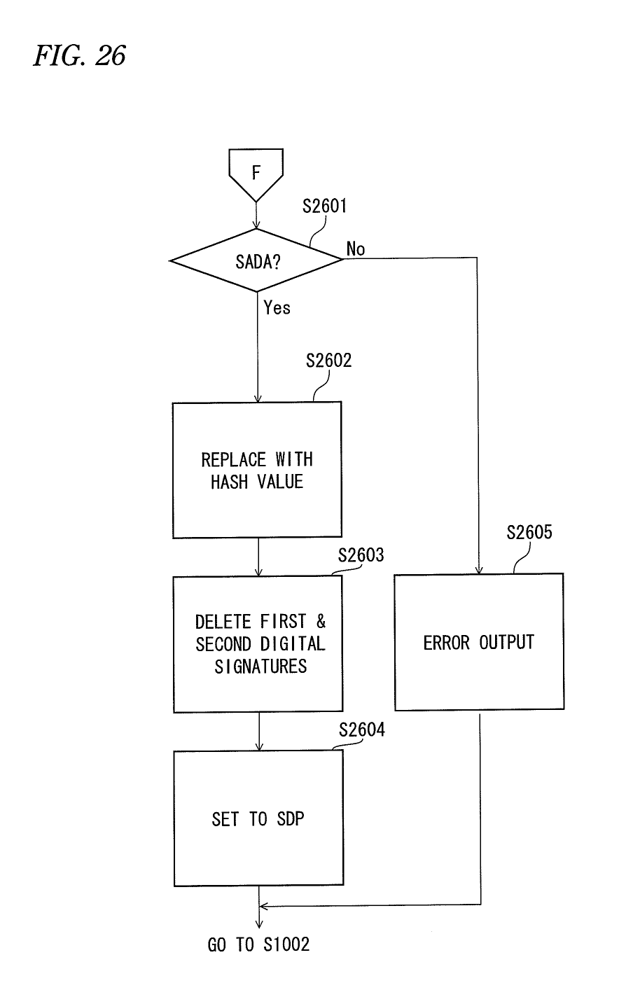

In a flow chart of FIG. 26, the judgment unit 303 judges whether a state of a partial document mi′ designated to be “sanitized and deletion prohibited” is SADA or not (Step S2601). When the state is SADA (Step S2601: Yes), the partial document mi′ designated to be “sanitized and deletion prohibited” is replaced with a hash value hi′ (Step S2602).

After that the deletion unit 304 deletes the first digital signature σi and the second digital signature τi specified for the partial document mi′ designated to be “sanitized and deletion prohibited” (Step S2603). Then a setting unit 305 changes the state of the partial document mi′ designated to be “sanitized and deletion prohibited” from SADA to SDP (Step S2604), and the flow returns to Step S1002 shown in FIG. 10.

When the state is not SADA at step S2601 (Step S2601: No), the output unit 306 outputs an error notifying that the partial document mi′ which cannot be designated to be “sanitized and deletion prohibited” is designated (Step S2605). Then the flow returns to Step S1002 shown in FIG. 10.

According to the above explained third embodiment, for a partial document mi′ comprising an electronic document M, either one of the following states can be set: SADA, SADP, SDA, SDP, SPDA, SPDP, or D. For transitions between these states, the state transitions from T1 to T12 can be realized.

This third embodiment, compared to the second embodiment, can decrease the amount of data required to represent each state because the embodiment does not need a second digital signature τi to represent SDP.

### Fourth Embodiment

Now, the fourth embodiment is explained. A case is assumed that the state of a partial document of sanitization prohibited is not required when a Sanitizable and Deletable Signature is applied. Thus, in the fourth embodiment, SPDA and SPDP indicating the states of sanitization prohibited are disabled.

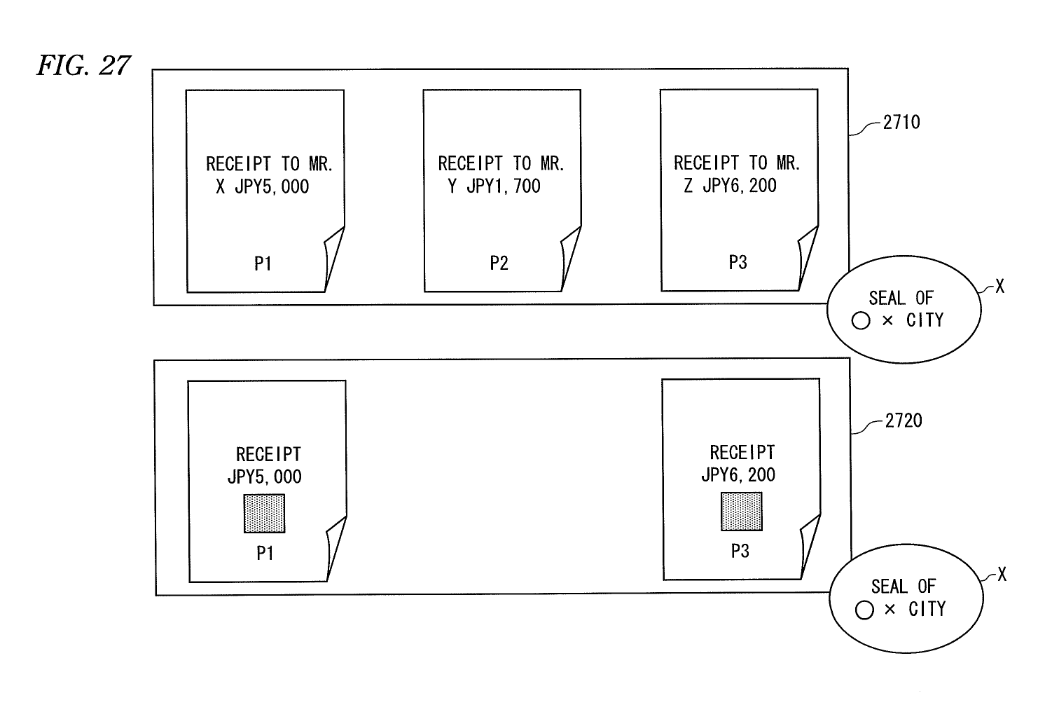

FIG. 27 is an explanatory diagram illustrating an example of drawbacks when a state of sanitization prohibited is not used. In FIG. 27, an original document 2710 is an electronic document of receipts stored by a certain city (AA city). More specifically, the information on the receipts including the payee is described on each page (Pages P1 to P3). The digital signature X indicating an official seal of the city is applied to the original document 2710. Hereunder, character strings on the original document 2710 are assumed to be a partial document.

When a user (verifier) requests disclosure of information, disclosing the document as it is leads to disclosure of the personal information to the verifier because the original document 2710 has personal information. Thus partial concealment of personal information is required. Assume that the method to conceal information here is limited to sanitization, for example, by an ordinance. The original document 2710 includes all receipts stored by AA city, thus only required receipts need to be extracted.

Then, assume the case where a redacted document is created from the original document 2710 using the Sanitizable and Deletable signature as a method to conceal information. The Sanitizable and Deletable signature allows partial deletion of information. Therefore only the required receipts can be extracted by deleting unnecessary pages from the original document 2710.

The Sanitizable and Deletable signature allows sanitization of partial information. Thus only required information can be disclosed by sanitizing unnecessary information in the original document 2710. Therefore a redacted document 2720 can be created by using the Sanitizable and Deletable signature.

When the redacted document 2720 is disclosed, a verifier cannot identify specific contents of the second page and personal information included in the first and the third pages, thereby the concealment of information is achieved. Therefore the redacted document 2720 is a desirable document.

When, for some reasons, for example, “sanitization prohibited” is set as a state for a partial document of all receipts which describe a payee, the payee's information cannot be concealed by sanitization. And, an appropriate redacted document cannot be created. Thus, the fourth embodiment prevents these problems by disabling SPDA and SPDP that indicate “sanitization prohibited”.

### [States of a Partial Document and the State Transitions]

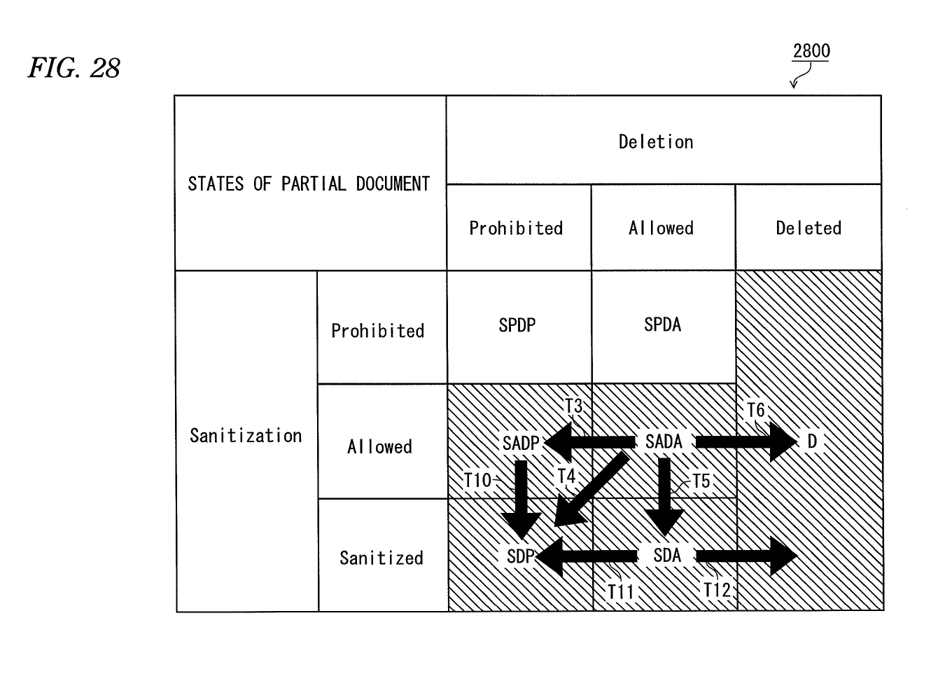

First, states of a partial document and the state transitions are explained. FIG. 28 is a diagram illustrating states of a partial document and the state transitions. In FIG. 28, a diagram 2800 illustrates various states that can be set for each partial document comprising the electronic document M. Here, SADA, SADP, SDA, SDP and D can be set, while “Sanitization Prohibited and Deletion Allowed” (SPDA) and “Sanitization Prohibited and Deletion Prohibited” (SPDP) cannot be set.

In a diagram 2800, as the transitions between these states, seven states of transitions from T3 to T6 and from T10 to T12 are shown. These state transitions from T3 to T6 and from T10 to T12 indicate the transitions that the state of each partial document can be changed to another state when a redactor applies a redaction to each partial document.

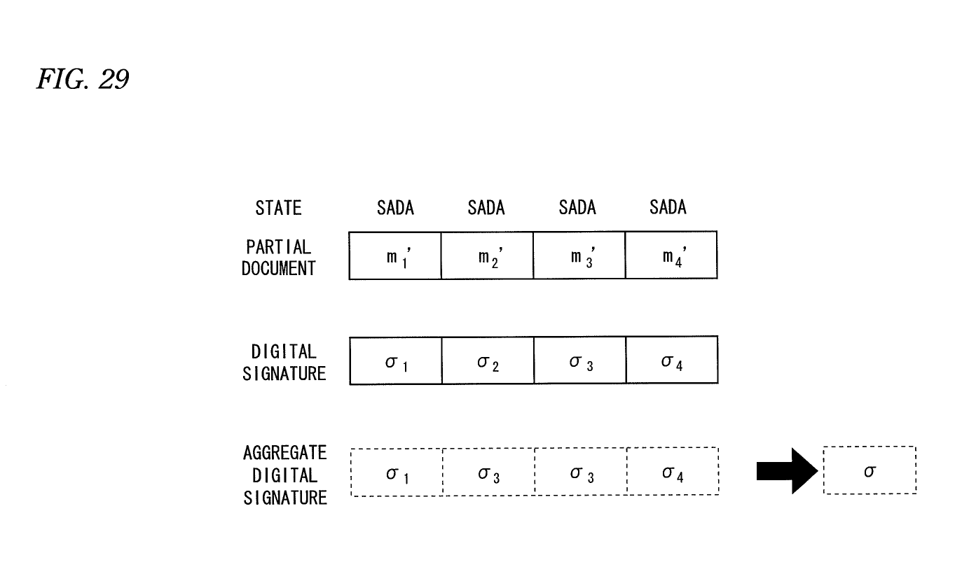

Now, the initial state of an electronic document M is explained. FIG. 29 is an explanatory diagram illustrating an example of the initial state of an electronic document M according to the fourth embodiment. In FIG. 29, the electronic document M is divided into a plurality of documents from m1′ to m4′. For each partial document from m1′ to m4′, first digital signatures from σ1 to σ4 are specified respectively. Meanwhile, an aggregate digital signature σ which aggregates the first digital signatures from σ1 to σ4 are linked to the electronic document M. At an initial state of the electronic document M, states of these partial documents from m1′ to m4′ are “Sanitization Allowed and Deletion Allowed” (SADA).

### [Method for Representing States of Partial Documents]

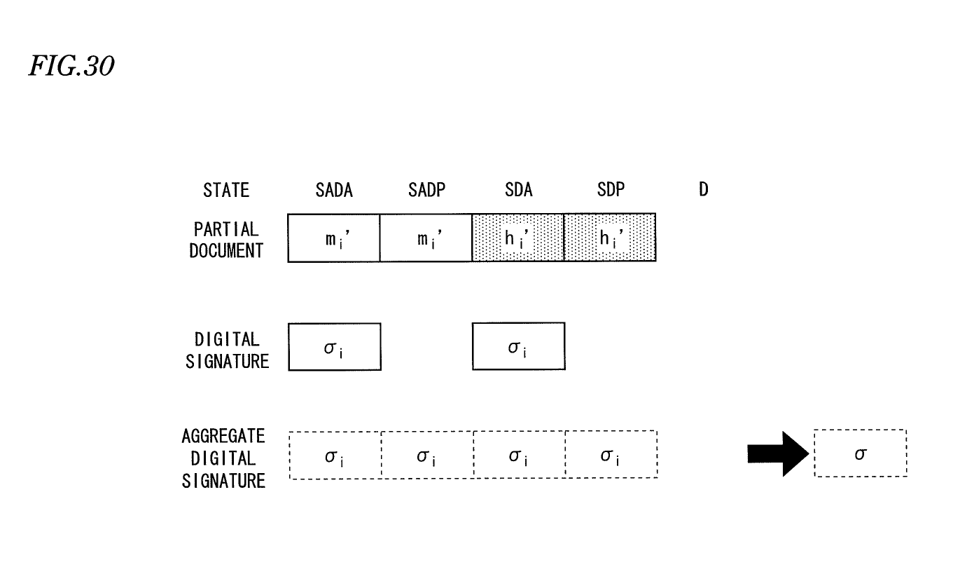

Now, a method for representing states of each partial document mi′ is explained. FIG. 30 is an explanatory diagram illustrating a method for representing states of partial documents according to the fourth embodiment. In FIG. 30, a state of each the partial document mi′ is represented by a combination of a partial document mi′, the hash value hi′, and the first digital signature σi.

First, “Sanitization Allowed and Deletion Allowed” (SADA), which is an initial state, is represented by a combination of the partial document mi′, and the first digital signature σi. “Sanitization Allowed and Deletion Prohibited” (SADP) is represented by the partial document mi′. In this case the aggregate digital signature σincludes the first digital signature σi.

“Sanitized and Deletion Allowed” (SDA) is represented by a combination of a hash value hi′, and the first digital signature σi. “Sanitized and Deletion Prohibited” (SDP) is represented by the hash value hi′. For states of above SADA, SADP, SDA, and SDP, the aggregate digital signature σ includes the first digital signature σi.

“Deleted” (D) is represented by a combination of the absence of partial document mi′, the hash value hi′, and the first digital signature σi. In this case the first digital signature σi is deleted from the aggregate digital signature σ.

### [Transitions Between States]

Now, the state transitions from T3 to T6 and from T10 and T12 shown in FIG. 28 are explained. First, the state transition T3 indicates the transition from SADA to SADP. In order to enable this transition, the first digital signature σi specified for the partial document mi′ is deleted.

The state transition T4 indicates the transition from SADA to SDP. In order to enable this transition, the partial document mi′ is replaced with the hash value hi′ and the first signature σi specified for the partial document mi′ is deleted as well.

The state transition T5 indicates the transition from SADA to SDA. In order to enable this transition, the partial document mi′ is replaced with the hash value hi′. The transition from SDA to SADA is not allowed.

The state transition T6 indicates the transition from SADA to D. In order to enable this transition, a first digital signature σi specified for the partial document mi′ is deleted from an aggregate digital signature σ, and the partial document mi′ and the first digital signature σi specified for the partial document are deleted as well.

The state transition T10 indicates the transition from SADP to SDP. In order to enable this transition, the partial document mi′ is replaced with the hash value hi′. The state transition T11 indicates the transition from SDA to SDP. In order to enable this transition, the first digital signature σi specified for the partial document mi′ is deleted.

The state transition T12 indicates the transition from SDA to D. In order to enable this transition, the first digital signature σi specified for the partial document mi′ is deleted from the aggregate digital signature σ and the hash value hi′ and the first digital signature σi specified for the partial document mi′ are all deleted.

### [Processing Procedures of Redaction]

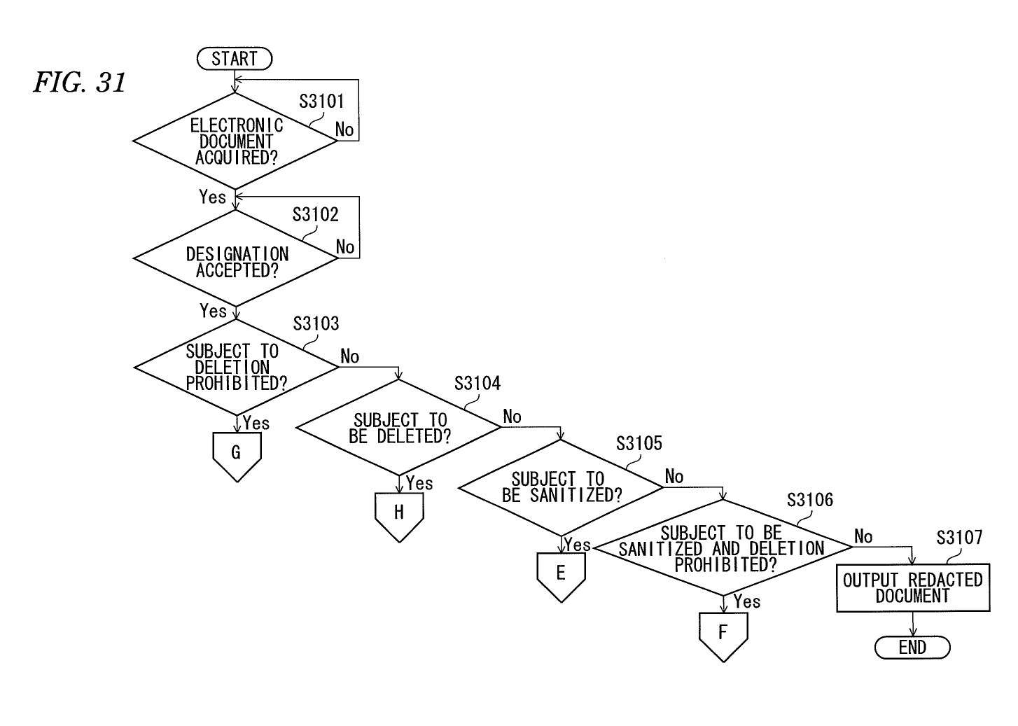

Processing procedures of a redaction according to the fourth embodiment is explained. FIGS. 31 to 33 are flow charts illustrating processing procedures of a redaction according to the fourth embodiment. Duplicative processing performed in the first embodiment and the fourth embodiment will not be described here (e.g. steps shown in FIGS. 15 and 16).

In a flow chart of FIG. 31, whether an acquisition unit 301 acquires an electronic document M comprised of a plurality of partial documents from m1′ to mn′ or not is judged (Step S3101). More specifically, for example, the electronic document M shown in FIG. 29 is obtained.

The electronic document management apparatus waits until the acquisition unit 301 acquires the electronic document M (Step S3101: No), and when the acquisition unit 301 acquires the document (Step S3101: Yes), whether the designation of a redaction by a redactor's input is accepted by the designation unit 302 or not is judged (Step S3102). After waiting for the designation, and when the designation is accepted by the designation unit 302 (Step S3102), whether designation of a subject to be “deletion prohibited” is accepted or not is judged (Step S3103).

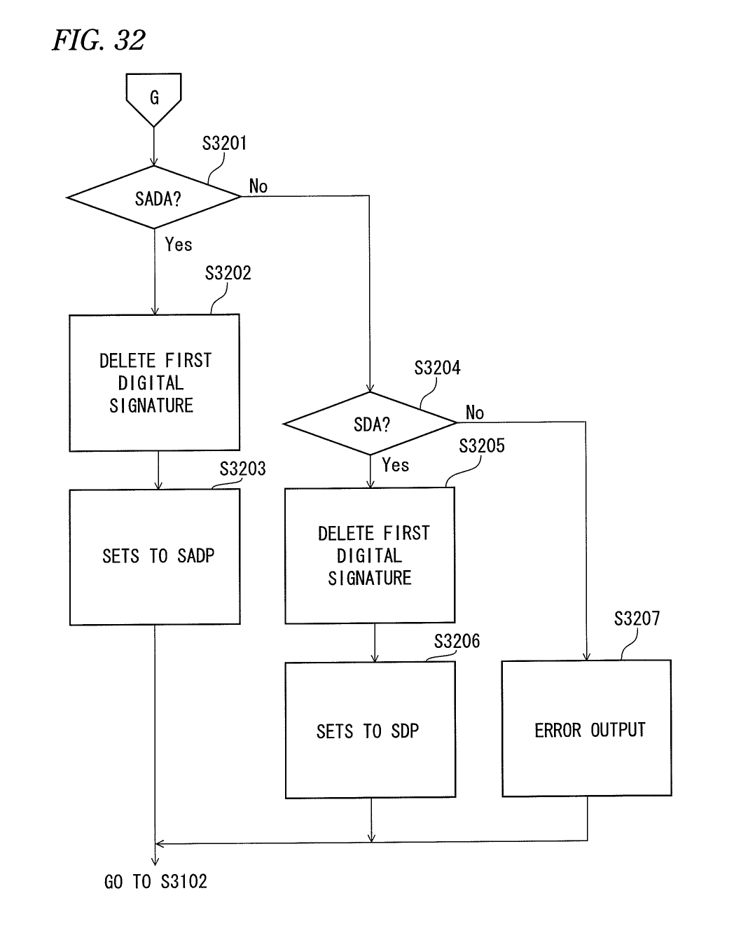

When designation of a subject to be “deletion prohibited” is accepted (Step S3103: Yes), the flow proceeds to Step S3201 shown in FIG. 32. When the designation of a subject to be “deletion prohibited” is not accepted (Step S3103: No), whether designation of a subject to be “deletion prohibited” is accepted or not is judged (Step S3104).

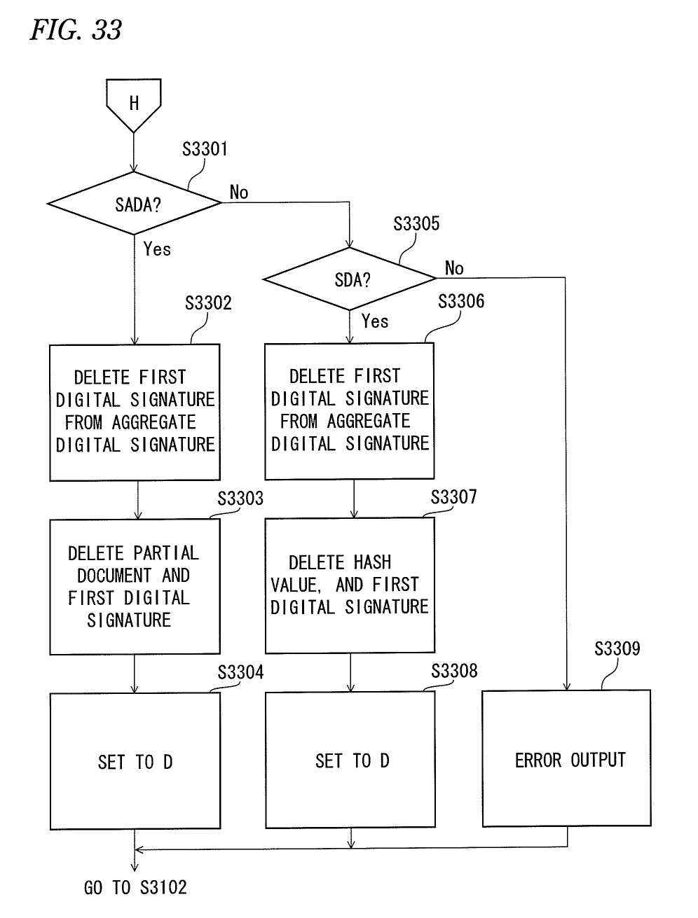

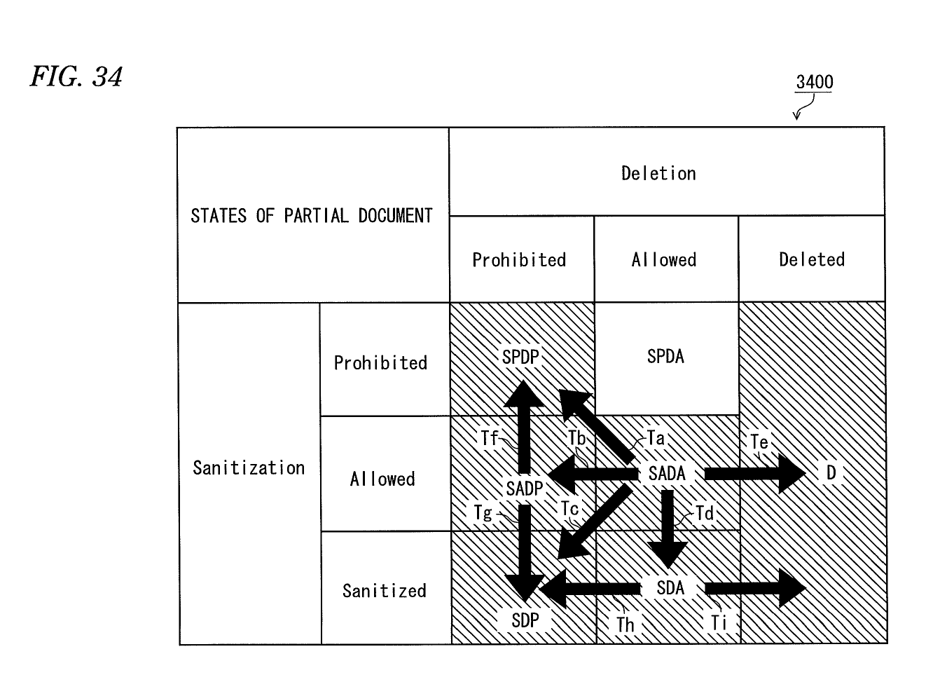

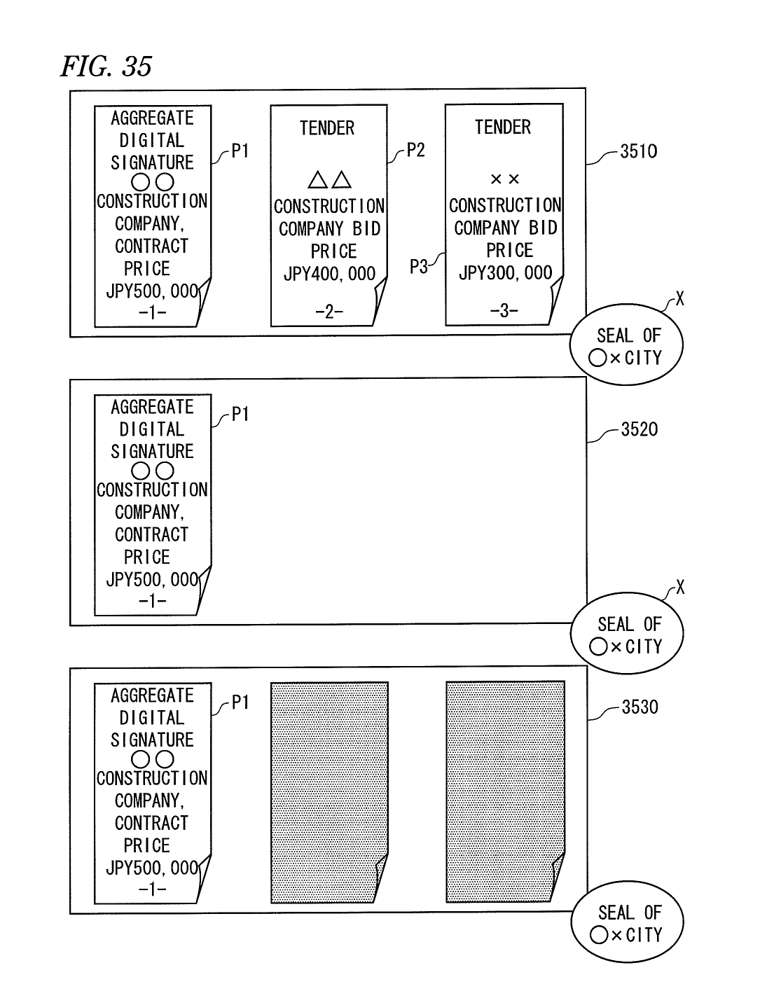

When designation of a subject to be “deleted” is accepted (Step S3104: Yes), the flow proceeds to step S3301 shown in FIG. 33. When the designation of a subject to be “deleted” is not accepted (Step S3104: No), whether designation of a subject to be “sanitized” is accepted or not is judged (Step S3105).

When designation of a subject to be “sanitized” is accepted (Step S3105: Yes), the flow proceeds to step S1501 shown in FIG. 15. When the designation of a subject to be “sanitized” is not accepted (Step S3105: No), whether designation of a subject to be “sanitized and deletion prohibited” is accepted or not is judged (Step S3106).

When designation of a subject to be “sanitized and deletion prohibited” is accepted (Step S3106:Yes), the flow proceeds to step S1601 shown in FIG. 16. When such designation is not accepted (Step S3106: No), the judgment unit 303 judges that designation indicating completion of the redaction is accepted and an output unit 306 outputs the redacted document R (Step S3107), thereby completing a series of processes by this flow chart.

In a flow chart of FIG. 32, first the judgment unit 303 judges whether a state of a partial document mi′ designated to be “deletion prohibited” is SADA or not (Step S3201). When the state is SADA (Step S3201:Yes), the deletion unit 304 deletes the first digital signature σi specified for the partial document mi′ designated to be “deletion prohibited” (Step S3202).

Then a setting unit 305 changes the state of the partial document mi′ designated to be “deletion prohibited” from SADA to SADP (Step S3203), and the flow returns to Step S3102 shown in FIG. 31. When the state is not SADA at Step S3201 (Step S3201: No), the judgment unit 303 judges whether the state of a partial document mi′ designated to be “deletion prohibited” is SDA or not (Step S3204). When the state is SDA (Step S3204:Yes), the deletion unit 304 deletes the first digital signature σi specified for the partial document mi′ designated to be “deletion prohibited” (Step S3205).

Then a setting unit 305 changes the state of the partial document mi′ designated to be “deletion prohibited” from SDA to SDP (Step S3206), and returns to step S3102 shown in FIG. 31. When the state is not SDA at step S3204 (Step S3204: No), the output unit 306 outputs an error notifying that the partial document mi′ which cannot be designated to be “deletion prohibited” is designated (Step S3207). Then the flow returns to the Step S3102 shown in FIG. 31.

In a flow chart of FIG. 33, the judgment unit 303 judges whether a state of a partial document mi′ which is designated to be “deleted” is SADA or not (Step S3301). When the state is SADA (Step S3301:Yes), the deletion unit 304 deletes the first digital signature σi specified for the partial document mi′ designated to be “deleted” from the aggregate digital signature σ (Step S3302).

Then, the deletion unit 304 deletes the partial document mi′ designated to be “deleted”, and the first digital signature σi specified for the partial document mi′ (Step S3303). Then a setting unit 305 changes the state of the partial document mi′ designated to be “deleted” from SADA to D (Step S3304), and the flow returns to step S3102 shown in FIG. 31.

When the state is not SADA at Step S3301 (Step S3301: No), the judgment unit 303 judges whether the state of partial document mi′ designated to be “deleted” is SPDA or not (Step S3305). When the state is SDA (Step S3305:Yes), the deletion unit 304 deletes the first digital signature σi specified for the partial document mi′ designated to be “deleted” from the aggregate digital signature σ (Step S3306).

Then, the deletion unit 304 deletes a hash value hi′ of the partial document mi′ designated to be “deleted”, and the first digital signature σi specified for the partial document mi′ (Step S3307). Then a setting unit 305 changes the state of the partial document mi′ which is designated to be “deleted” from SDA to D (Step S3308), and the flow returns to Step S3102 shown in FIG. 31.

When the state is not SDA at step S3305 (Step S3305: No), the output unit 306 outputs an error notifying that the partial document mi′ which cannot be designated to be “deleted” is designated (Step S3309). Then the flow returns to the Step S3102 shown in FIG. 31.

According to the above explained fourth embodiment, a method to represent states of SADA, SADP, SDA, SDP and D can be simplified by disabling the transitions to SPDP and SPDA. This can substantially reduce amount of data required to represent the above five states compared to the first to third embodiments.

As explained above, according to the electronic document management program, the storage media storing the program, the electronic document management apparatus, and the method to manage electronic documents, more flexible redaction to an electronic document and higher usability are realized. These are achieved by enabling settings for a partial document that is “sanitization prohibited and deletion allowed”.

The method for managing electronic documents can be realized by causing a computer such as a personal computer and a workstation to execute a prepared program. Such program is stored in computer-readable storage media such as hard disks, flexible disks, CD-ROMs, magneto-optical disks, and DVDs and executed by being read by a computer. The program may be transmission media distributable through a network such as the Internet.

What is claimed is:

1. A storage medium storing an electronic document management program causing a computer to enable the following units:
an acquisition unit for acquiring an electronic document comprised of a plurality of components for each of which a first digital signature and a second digital signature are uniquely specified, the electronic document being linked to an aggregate digital signature which aggregates the first digital signatures,
a designation unit for accepting the designation of a selected component to be “hiding prohibited”,
a judgment unit for judging whether the selected component is in a state of “hiding allowed and deletion allowed” based on the existence or non-existence of the component designated to be “hiding prohibited” by the designation unit and the first and the second digital signatures specified for the component,
a deletion unit for deleting a second digital signature specified for the component designated to be “hiding prohibited” when the judgment unit judges that the state is “hiding allowed and deletion allowed”, and
a setting unit for changing the state of the component subject to becoming “hiding prohibited” as a result of the deletion by the deletion unit from “hiding allowed and deletion allowed” to “hiding prohibited and deletion allowed”.

2. A computer-readable storage media storing an electronic document management program according to claim 1, wherein
when the designation unit accepts the designation of a second selected component to be “deletion prohibited”, the judgment unit judges whether the component is in a state of “hiding prohibited and deletion allowed” or not, based on the existence or non-existence of the component designated to be “deletion prohibited” by the designation unit and the first digital signature specified for the component,
the deletion unit deletes a first digital signature specified for the component designated to be “deletion prohibited” when the judgment unit judges the state is “hiding prohibited and deletion allowed”, and
the setting unit changes the state of the component subject to become “deletion prohibited” as a result of the deletion by the deletion unit from “hiding prohibited and deletion allowed” to “hiding prohibited and deletion prohibited”.

3. A computer-readable storage media storing an electronic document management program according to claim 1, wherein
the designation unit accepts the designation of a component subject to be “deleted” among the electronic document, the judgment unit judges whether the component is in a state of “hiding prohibited and deletion allowed” or not, based on the existence or non-existence of the component designated to be deleted by the designation unit and the first digital signature specified for the component,
the deletion unit deletes the first digital signature specified for the component designated to be deleted from the aggregate digital signature and deletes the component and the first digital signature specified for the component as well when the judgment unit judges the state is “hiding prohibited and deletion allowed”, and
the setting unit changes the state of the component subject to become deleted as a result of the deletion by the deletion unit from “hiding prohibited and deletion allowed” to be deleted.

4. A computer-readable storage media storing an electronic document management program according to claim 1, wherein
the acquisition unit acquires a redacted document to which a state of the component is set by the setting unit, and
the computer enables a verification unit to verify authenticity of the redacted document acquired by the acquisition unit based on the first digital signature, the second digital signature and the aggregate digital signature, and an output unit to output results verified by the verification unit.

5. A computer-readable storage media storing an electronic document management program according to claim 1, wherein
the acquisition unit acquires an electronic document comprised of a plurality of components for each of which a first digital signature and a second digital signature are uniquely specified, the electronic document being linked to a first aggregate digital signature which aggregates the first digital signatures, and a second aggregate digital signature which aggregates the second digital signatures,
the designation unit accepts the designation of a component to be “hiding prohibited” among the electronic document acquired by the acquisition unit,
the judgment unit judges whether the component is in a state of “hiding allowed and deletion allowed” based on the existence or non-existence of the component designated to be “hiding prohibited” by the designation unit and the first and the second digital signatures specified for the component,
the deletion unit deletes the second digital signature specified for the component designated to be “hiding prohibited” from the second aggregate digital signature and deletes the second digital signature specified for the component when the judgment unit judges that the state is “hiding allowed and deletion allowed”,
the setting unit changes a state of the component subject to become “hiding prohibited” as a result of the deletion by the deletion unit from “hiding allowed and deletion allowed” to “hiding prohibited and deletion allowed”.

6. A computer-readable storage media storing an electronic document management program according to claim 5, wherein
the designation unit accepts the designation of a component to be “deletion prohibited” among the electronic document,
the judgment unit judges whether the component is in a state of “hiding prohibited and deletion allowed” or not, based on the existence or non-existence of the component designated to be deletion prohibited by the designation unit and the first digital signature specified for the component,
the deletion unit deletes the first digital signature specified for the component designated to be “deletion prohibited” when the judgment unit judges the state is “hiding prohibited and deletion allowed”, and
the setting unit changes a state of the component subject to become “deletion prohibited” as a result of the deletion by the deletion unit from “hiding prohibited and deletion allowed” to “hiding prohibited and deletion prohibited”.

7. A computer-readable storage media storing an electronic document management program according to claim 5, wherein
the designation unit accepts the designation of a component to be deleted among the electronic document and the judgment unit judges whether the component is in a state of “hiding prohibited and deletion allowed” or not, based on the existence or non-existence of the component designated to be deleted by the designation unit and the first digital signature specified for the component,
the deletion unit deletes the first digital signature specified for the component designated to be deleted from the first aggregate digital signature and deletes the component and the first digital signature specified for the component as well when the judgment unit judges that the state is “hiding prohibited and deletion allowed”, and
the setting unit changes a state of the component that is a subject to become deleted as a result of the deletion by the deletion unit from “hiding prohibited and deletion allowed” to “deleted”.

8. A computer-readable storage media storing an electronic document management program according to claim 1, wherein
the acquisition unit acquires a redacted document to which a state of the component is set by the setting unit, and
the verification unit verifies authenticity of the redacted document acquired by the acquisition unit based on the first digital signature, the second digital signature, the aggregate digital signature of the first digital signature and the aggregate digital signature of the second digital signature.

9. An electronic document management apparatus comprising:
an acquisition unit for acquiring an electronic document comprised of a plurality of components, for each of which a first digital signature and a second digital signature are uniquely specified, the electronic document being linked to an aggregate digital signature which aggregates the first digital signatures,
a designation unit for accepting the designation of a selected component to be “hiding prohibited”,
a judgment unit for judging whether the selected component is in a state of “hiding allowed and deletion allowed” or not, based on the existence or non-existence of the component designated to be “hiding prohibited” by the designation unit and the first and the second digital signatures specified for the component,
a deletion unit for deleting a second digital signature specified for the component designated to be “hiding prohibited” when the judgment unit judges that the present state is “hiding allowed and deletion allowed”, and
a setting unit for changing the state of the component subject to become “hiding prohibited” as a result of the deletion by the deletion unit from “hiding allowed and deletion allowed” to “hiding prohibited and deletion allowed”.
